(19) United States
(12) Patent Application Publication
(10) Pub. No.: US 2023/0214236 A1
(43) Pub. Date: Jul. 6, 2023

(54) MASKING ROW OR COLUMN POSITIONS FOR MATRIX PROCESSING

(71) Applicant: Arm Limited, Cambridge, Cambridgeshire (GB)

(72) Inventor: David Hennah MANSELL, Cambridge, Cambridgeshire (GB)

(21) Appl. No.: 17/998,221

(22) PCT Filed: May 13, 2021
(86) PCT No.: PCT/GB2021/051149

§ 371 Date: Nov. 8, 2022

(30) Foreign Application Priority Data
May 13, 2020 (GB) 2007069.4

(51) Int. Cl. G06F 9/448; G06F 17/16

(52) U.S. Cl. CPC G06F 9/448; G06F 17/16

(57) ABSTRACT

An apparatus comprises matrix processing circuitry to perform a matrix processing operation on first and second input operands to generate a result matrix, where the result matrix is a two-dimensional matrix; operand storage circuitry to store information for forming the first and second input operands for the matrix processing circuitry; and masking circuitry to perform a masking operation to mask at least part of the matrix processing operation or the information stored to the operand storage circuitry based on masking state data indicative of one or more masked row or column positions to be treated as representing a masking value. This is useful for improving performance of two-dimensional convolution operations, as the masking can be used to mask out selected rows or columns when performing the 2D convolution as a series of 1×1 convolution operations applied to different kernel positions.

The present technique relates to the field of data processing. More particularly it relates to matrix processing.

Matrix processing operations which generate a two-dimensional matrix as a result matrix can be an important operation in some fields of data processing, for example in machine learning or image processing.

At least some examples provide an apparatus comprising: matrix processing circuitry to perform a matrix processing operation on first and second input operands to generate a result matrix, where the result matrix is a two-dimensional matrix; operand storage circuitry to store information for forming the first and second input operands for the matrix processing circuitry; and masking circuitry to perform a masking operation to mask at least part of the matrix processing operation or the information stored to the operand storage circuitry based on masking state data indicative of one or more masked row or column positions to be treated as representing a masking value.

At least some examples provide an apparatus comprising: means for performing a matrix processing operation on first and second input operands to generate a result matrix, where the result matrix is a two-dimensional matrix; means for storing information for forming the first and second input operands for the means for performing; and means for performing a masking operation to mask at least part of the matrix processing operation or the information stored to the operand storage circuitry based on masking state data indicative of one or more masked row or column positions to be treated as representing a masking value.

At least some examples provide a data processing method comprising: storing, in operand storage circuitry, information for forming first and second input operands for a matrix processing operation; and performing a matrix processing operation on the first and second input operands to generate a result matrix, where the result matrix is a two-dimensional matrix; and performing a masking operation to mask at least part of the matrix processing operation or the information stored to the operand storage circuitry based on masking state data indicative of one or more masked row or column positions to be treated as representing a masking value.

### BRIEF DESCRIPTION OF THE DRAWINGS

Further aspects, features and advantages of the present technique will be apparent from the following description of examples, which is to be read in conjunction with the accompanying drawings, in which:

FIG. 1 illustrates an example of unpadded two-dimensional (2D) convolution;

FIG. 2 shows an example of padded 2D convolution;

FIG. 3 shows an example in which 2D convolution is applied to input data comprising multiple channels, to generate output data comprising multiple channels;

FIG. 4 shows an example of a memory layout for storing the data for the input data in memory;

FIG. 5 shows, for comparison, an approach in which the input channel data stored in memory is rearranged to generate a number of rows of data stored in memory, to simplify subsequent 2D convolution processing applied to the remapped rows;

FIG. 6 shows a different approach where the 2D convolution operation is split into a number of 1×1 convolutions;

FIG. 7 shows how masking of selected rows or columns of an operand matrix enables the 2D convolution to be implemented by a series of 1×1 convolutions without needing the step of rearranging the data in memory;

FIG. 8 illustrates how applying a variable position shift between the input and output of a given matrix operation enables the same set of input channel data loaded from memory to be reused across multiple different 1×1 convolution operations for different kernel positions;

FIG. 9 schematically illustrates a data processing apparatus having matrix processing circuitry;

FIG. 10 schematically illustrates part of the matrix processing circuitry and registers used by the matrix processing circuitry;

FIGS. 11 to 13 illustrate different ways of representing addressing information and masking state information for the matrix processing operation;

FIG. 14 shows an example where the matrix processing operation is an outer product information and the apparatus has position shifting circuitry to apply a variable position shift;

FIG. 15 shows an example of processing a load instruction to load a target row or column for the matrix processing operation;

FIG. 16 shows a method of processing a matrix processing instruction; and

FIG. 17 shows a second example of processing a matrix processing instruction.

### DETAILED DESCRIPTION

### Row or Column Masking for Matrix Processing Operations

Two-dimensional (2D) convolution operations are a popular operation in the field of machine learning, particularly for neural networks. 2D convolutions can also be used for other purposes such as applying filters to images. In a 2D convolution operation, a kernel is provided to define the filter or other operation to be applied. The kernel is applied to one or more input channels which each comprise a matrix typically of greater size than the kernel. In the 2D convolution operation, for a given output element position within an output matrix, the value for the given output element position depends on a sum of products of respective pairs of kernel values and input channel values. For each output matrix position the selection of the input channel values to multiply with the corresponding kernel values is different. For a given output element position, the kernel values that are multiplied with the corresponding input matrix elements are those which are aligned in position when the kernel is logically positioned so that the central kernel element is over the element of the input matrix that corresponds in position to the given output element position. Examples of 2D convolution are described further below.

One reason why 2D convolution operations are relatively complex to implement in data processing is that they may require calculation of sums of products of a number of pairs of kernel and input elements for many different combinations of the kernel values and input elements, including adding products involving input matrix elements which may not be stored at adjacent addresses within a memory address space. Hence, a typical approach for performing 2D convolutions is to perform (prior to the sum-of-product calculations themselves), some remapping (rearrangement) operations to remap the data stored for the input matrix in memory, so as to generate a number of bespoke data structures which correspond to the values to be operated on for each respective kernel position of the kernel. However, this remapping involves many instances of copying data from one memory location to another, which incurs extra latency and wastes memory space. Hence, it may be desirable to find a way of implementing 2D convolution so that the operations required can be applied directly based on the layout of the input channel data within the memory space without needing such remapping.

In the examples below an apparatus has matrix processing circuitry to perform a matrix processing operation on first and second input operands to generate a result matrix, where the result matrix is a two-dimensional matrix. The first and second input operands do not themselves need to be two-dimensional and in some examples may be one-dimensional vectors, although other examples could apply the matrix processing operation to two-dimensional input operands. Operand storage circuitry is provided to store information forming the first and second input operands for the matrix processing circuitry. Masking circuitry performs a masking operation to mask at least part of the matrix processing operation or the information stored to the operand storage circuitry based on masking state data indicative of one or more masked row or column positions to be treated as representing a masking value. The masking state data could be defined as an operand of the matrix processing instruction which instructs the matrix processing circuitry to perform the matrix processing operation, or may be some stored state data which is configured separately and is not explicitly referenced by the matrix processing instruction.

By providing masking based on masking state data indicative of masked row/column positions, this enables the matrix processing to skip certain rows or columns of input data, which can be particularly useful for 2D convolution operations. The masking circuitry could perform the masking operation either at the time of loading operands into the operand storage circuitry, or at the time of performing the matrix processing operation itself, or both on loading the operand storage circuitry and on performing the matrix processing operation.

This approach helps to support more efficient 2D convolution operations. For example, the 2D convolution operation may be split (by software) into a number of separate 1×1 convolution operations which apply kernel value(s) from a single kernel position within a larger kernel matrix to a number of input matrix elements of a given input channel, and update respective elements within an output matrix based on the result (in some cases multiple channels of such 1×1 convolution processing could be done in parallel). Such 1×1 convolutions would allow the operation for a given kernel position to be applied without needing remapping of the structure in memory, with successive results of 1×1 convolutions for different kernel positions being accumulated together (with an appropriate shift of the output matrix elements being updated relative to the input matrix elements used to calculate those outputs, to account for which kernel position is being applied), so that after performing the 1×1 convolutions for each kernel position the result is equivalent to the result of the 2D convolution.

To support this, it can be useful to provide the masking circuitry which can be controlled, based on the masking state data, to mask out a given row or column position so that the data from some rows/columns of the corresponding input channels can be treated as if it represents a masking value instead of the actual data stored in memory. This is because when the 2D convolution is split into successive 1×1 convolutions, while for most output element positions the correct result for a given 1×1 convolution can be achieved by reading a corresponding input matrix element, multiplying that element by a corresponding kernel value, and writing the result to a corresponding output matrix element (with a shift in position between the relative position of the input matrix element within the input matrix and the relative position of the corresponding output matrix element within the output matrix, and that shift being by the same number of element positions for each of the multiplications being performed for a given kernel position). However, at the edges of the matrix there are some elements for which this approach would give the wrong result, e.g. due to an element on one edge of the output matrix being updated based on an element at the opposite edge of the input matrix, causing an error preferred to below as a ‘wraparound’ error. By providing the masking operation, this allows rows or columns of the input data which should not affect the output to be masked out. Hence, by providing support for masking of rows/columns, this can enable improved performance for 2D convolution operations which can be an important for neural network performance.

It will be appreciated that the control of which particular rows/columns of a matrix are masked out is controlled by software, so is not a feature of a particular processor implementation. The apparatus provides features which enable software to select the rows/columns to be masked.

When a given row or column of the given operand matrix is indicated as masked by the masking state data, there may be different options for selecting the masking value to be used for that row/column position. For many practical applications it can be useful for the masking value to be zero. This can help to support the skipping of rows to deal with the ‘wraparound’ problem described above where the rows/columns on one edge of the input matrix should be prevented from affecting the calculation of output matrix elements on the opposite edge. Also, the masking value of zero can be useful for enabling padding values to be supplied to be multiplied with kernel elements which are positioned outside the bounds of the input matrix when a padded 2D convolution operation is applied and the kernel is at a position centred near the edge of the input matrix. Hence, in some hardware implementations it may be sufficient that the masking circuitry supports only a fixed masking value to be used for any masked row/column positions, e.g. a masking value of zero.

However, for some applications using 2D convolutions, it may be desired to use padding values other than zero (e.g. if the matrices are represented using a quantization scheme where each value is offset from its true value by a certain number, so that the “zero point” is represented by a numeric value other than zero). To support such operations, it can be useful to provide the ability to select a non-zero value as a masking value. Therefore, in some implementations, in the masking operation, the masking value can be selected from among a plurality of masking values (e.g. zero or another pre-configured value), based on at least one of: a masking value selection parameter specified by the instruction which causes the masking operation to be performed (e.g. a load instruction for loading information to the operand storage circuitry, or a matrix processing instruction for controlling the matrix processing circuitry to perform the matrix processing operation); a control value stored in a control register; and a masking vector specifying separate masking values for a plurality of elements of a masked row/column. With the last option, the masking vector could be read from a vector register.

The masking state data may have an encoding identifying, within a two-dimensional array of elements, elements to be treated as representing the masking value. Hence, the masking state data may (fully or partially) identify positions of masked elements across two dimensions. Providing state data which can apply masking in two dimensions can be useful for dealing with a number of issues involved in 2D convolution processing, including the “wraparound” error problem discussed above, the fact that at the tail of a loop there may be a number of “out of bounds” elements unused which extend beyond the end of the data structure to be processed, and with providing support for the “position shifting” feature described in more detail below.

For example, the masking state data could specify first masking state data indicative of one or more masked rows or column positions for which all elements in the masked row or column position are to be treated as representing the masking value, and second masking state data indicative of whether individual element positions within a given row or column are to be masked or not. The masking out of entire rows or columns using the first masking state data can be useful for dealing with the “wraparound” error and/or “out of bounds” rows/columns in a first dimension, and the individual masking of particular elements within a not-fully-masked row or column can be useful for supporting “out of bounds” columns/rows in a second dimension and/or the position shifting feature described below (or for more general per-element predication). The first masking state data may comprise a set of elements identifying the masked/non-masked row/column positions in one dimension (row or column), while the second masking state data may comprise a set of elements identifying masked/non-masked positions in the orthogonal dimension (column or row). In some cases, the second masking state data may specify the individual indications of masked/non-masked elements only for a single row/column, as the same set of second masking state data could be shared across rows/columns (or if different patterns of masked/non-masked elements are needed for different rows/columns, then the second masking state data could be adjusted between processing one row/column and the next).

The masking state data may have an encoding capable of indicating, as masked row or column positions, at least two non-adjacent row or column positions separated by at least one non-masked row or column position. This recognises that when a 2D convolution is split into a number of 1×1 convolutions then there may be a number of non-adjacent row or column positions that need to be masked to prevent the input values on one edge of the input matrix affecting the output values at the opposite edge of the output matrix. Also, the locations to be padded for padded 2D convolutions may not correspond to contiguous addresses in memory.

The masking state data can be represented in a number of different ways. In general the masking state data may be any set of information which can indicate which row/column positions within a matrix structure are to be masked. One approach can be that the masking state data (e.g. the first masking state information described above) comprises a number of masking state indicators each corresponding to a respective row or column position of a given operand matrix and indicating whether the corresponding row or column position is a masked row or column position. For example the masking state data could include a bitmap where each bit corresponds to a given row or column position and is set to one value if that row or column position is to be masked and to another value if that row or column position is to remain unmasked. Similarly, the second masking information may comprise a second bitmap indicating the masked row/element positions within a particular row/column.

It is not necessary for the masking state data to distinguish whether it refers to respective rows of the given operand matrix or to respective columns of the given operand matrix. Different software applications may choose different layouts for a matrix within memory (e.g. row-major or column major), but the format of the masking state data may be the same regardless.

The operand storage circuitry can be implemented in different ways. In some examples the operand storage circuitry may comprise a set of input registers from which the first and second operands can be read when performing a given matrix processing operation.

However, it can be useful to provide, as part of the operand storage circuitry, matrix transposition circuitry which comprises a number of storage units to store respective matrix elements of a given operand matrix. The storage units of the matrix transposition circuitry may be readable in row groups corresponding to rows of the given operand matrix, and may also be readable in column groups corresponding to columns of the given operand matrix. Providing such matrix transposition circuitry can be very helpful in dealing with the fact that different machine learning algorithms may use different layouts to store the input channel data within memory. For example, some algorithms may use a row-major layout in memory where the offset between the memory addresses of adjacent elements of the same row of the matrix is smaller than the offset between the memory addresses of elements in adjacent elements in the same column of the given operand matrix. Other algorithms may use a column-major layout where the offset between the addresses of adjacent elements in the same column is smaller than the offset between adjacent elements within the same row. The matrix transposition circuitry enables on the fly remapping of whether a row-major or column-major format is used, since it is possible that if the given operand matrix is written to the matrix transposition circuitry in row groups, it can be read out from the matrix transposition circuitry in column groups, or vice versa, so that the subsequent matrix processing operations can assume a consistent format regardless of whether the data for the input matrix stored in memory is row-major or column-major. This can simplify code development and avoids the need for remapping or rearrangement of data within the memory storage itself.

Note that the storage units of the matrix transposition circuitry do not need to be physically arranged in rows and columns. It is sufficient that the storage units of the matrix transposition circuitry are logically readable in groups of storage elements corresponding to rows or in groups corresponding to columns. For example, the matrix transposition circuitry can be implemented as set of registers which have multiple read/write ports so that portions of the registers can be addressed in different combinations. For example, if each register stores a row group, a column group may be considered to be formed by a set of portions of data (the set comprising one portion per register, at corresponding positions within each register). Alternatively, the opposite mapping may be used where each column group maps to one register and a row group is a stripe of portions of data within corresponding positions in each register. Also, note that it is not essential that “rows” of a matrix stored in memory are written into “row groups” of the matrix transposition circuitry – while this is possible, such rows of the matrix could equally well be written into “column groups” of the matrix transposition circuitry. Hence, the “row groups” and “column groups” of the storage units in the matrix transposition circuitry refer to orthogonal groupings by which the storage units of the matrix transposition circuitry can be read, but do not need to conform to the same row/column direction as the matrices in memory. In fact, to improve pipelining of reads/writes for the matrix transposition circuitry it can sometimes be useful to alternate the choice of whether successive groups of lines (either rows or columns) of an input matrix are written into the matrix transposition circuitry in row groups or column groups.

Hence, when loading data to the matrix transposition circuitry, load circuitry may select whether to load at least one row group or at least one column group of storage units of the matrix transposition circuitry based on a portion of the matrix data structure in memory. The selection of whether to load at least one row group or at least one column group may be based on one or both of: row/column direction selection information specified by the load instruction; and row/column direction selection information stored in a control register which is updatable in response to a row/column direction switching instruction. Some implementations could use only one of these options to determine whether to load a row group or a column group (either information specified by the load instruction, or information specified in the control register). Alternatively, an implementation could combine both of these pieces of information. For example, the control register bit could indicate either row mode or column mode, but a bit in the load instruction could indicate whether or not the meaning of the stored bit should be inverted (so that for load instructions with the “inverted” bit set, the instruction will load a row when the stored bit indicates a column and will load column when the stored bit indicates row). Similarly, on reading data out from the matrix transposition circuitry to supply an operand for a matrix processing operation (or to transfer information to operand registers from which operands may subsequently be obtained for a matrix processing operation), row/column direction selection information could specify whether to read a row group or a column group of the matrix transposition circuitry (again that selection information could be specified by an instruction and/or in a control register, with the option to use both combining the row/column direction bit in a register and the “inverted” bit in the instruction for store instructions similar to load instructions as described above).

The masking operation based on the masking state data could be performed at different times relative to the loading of operands for matrix processing and the processing of matrix processing operations themselves.

In some implementations, the matrix processing circuitry may comprise the masking circuitry. The masking circuitry of the matrix processing circuitry may be responsive to the masking information to perform the matrix processing operation with a portion of one of the first and second operands corresponding to the one or more masked row or column positions treated as representing the masking value instead of an actual value of the portion of said one of said first and second operands stored in the operand storage circuitry. Hence, although the actual data from the input channels can be loaded from memory to the operand storage circuitry as normal, replacement of such input data with a masking value to provide padding or to avoid the wraparound errors described above can be controlled by masking the data read from the operand storage circuitry on input to the matrix processing circuitry. This approach can be particularly useful for implementations which also support the option to apply variable position shifting as discussed further below.

In some implementations, the masking circuitry may be comprised by load circuitry which is responsive to a load instruction to load information corresponding to a target row or column of a given operand matrix to the operand storage circuitry based on a portion of a matrix data structure stored in memory. In this case, when the target row or column corresponds to a masked row or column position indicated by the masking state data, the load circuitry may load a portion of said operand storage circuitry corresponding to the target row or column with data having the masking value instead of data based on the portion of the matrix data structure stored in memory. With this approach, the masking can be applied at the point of loading the operands from memory, which avoids unnecessary loading of matrix elements which will be masked anyway. Out of bounds data (corresponding to addresses beyond the end of a data structure to be processed which are referenced by a load instruction in a final iteration of a loop due to the amount of data to be processed not corresponding to an exact multiple of the amount of data that can be processed in one iteration) can also be masked using the masking circuitry, to prevent them from being loaded and hence prevent address faults being raised by accesses to addresses which might be invalid.

Some hardware implementations could support both types of masking, which could be useful as, for example, padding and masking of out of bounds data may be more efficiently handled by masking at the point of loading, but if variable position shifting is supported then dealing with the “wraparound” errors of the type discussed above may require masking at different input rows/columns for different instances of reading the same set of input data, in which case applying the masking at the point of reading the operand storage circuitry to perform a particular matrix processing operation can be more effective. Hence, to provide greatest flexibility, some implementations may support both types of masking.

For those implementations which provide load circuitry comprising the masking circuitry to apply masking at the point of loading operand data from memory, when the masking state data corresponding to the target row or column indicates that the target row or column corresponds to a masked row or column position, the load circuitry may determine whether each of the matrix elements of the target row or column should be masked, based on a shared item of masking state data shared between the two or more matrix elements of the target row or column. Hence, it is not necessary to provide individual masking state for each individual element within the target row or column (although this would be possible if desired, as described above with the example of the second masking state data providing 2D masking). For the purpose of supporting the “split into 1×1 convolutions” approach to handling 2D convolutions, a common memory layout for input channel data is to group the input elements at the same x-y position for multiple input channels together in a contiguous block of memory, in which case it may be that the masking can be applied to an entire row or column of the input matrix structure defining the input data for each of those input channels. This means it can be sufficient to share an item of masking state data among a whole row or column of an operand matrix being processed.

For the load masking example, the masking state data could be represented using a set of masking state indicators (e.g. a bitmap) as discussed above.

However, another approach may be that the masking state data comprises a number of offset values each corresponding to a respective row or column position of the given operand matrix and indicating an offset of an address of a corresponding portion of a matrix data structure in memory relative to a base address. In this case, a masked row or column position may be indicated by the offset value for the masked row or column position having a predetermined reserved offset value. This approach can be useful because it means that the masking state data can be represented using part of the addressing information used to identify the memory addresses from which portions of the matrix data structure in memory should be loaded. Hence, for each respective row or column position, the base address and the corresponding offset value for that row or column position can be used to identify the address in memory from which a portion of the matrix data structure should be loaded when the offset value does not have the predetermined reserved offset value. However, if the offset value for a given row or column position has the predetermined reserved offset value then instead of loading in the corresponding portion of the matrix data structure in memory, the masking value may be written to the portion of the operand storage circuitry which would otherwise store the portion of the matrix for that row or column. Hence, this approach avoids the need to provide separate masking state data beyond state data used for addressing of the matrix data structure in memory. The predetermined reserved offset value could be any reserved value that is designated as not being allowed to be used for real offset values, such as -1 (e.g. in signed binary representation, a value where all offset bits are 1).

In one example the masking state data may be stored within at least one masking state register provided within the processing apparatus. For example, there may be certain instructions for writing masking state data to the masking state register(s), prior to executing load instructions for loading portions of the operand matrix under control of the masking state data.

The masking state register could be a dedicated register provided specifically for controlling masking when performing matrix processing and/or loading operands for the matrix processing.

In other examples, the at least one masking state register could comprise at least one predicate register. In response to a vector instruction (or single instruction multiple data instruction) for controlling processing circuitry to perform vector processing using one or more vector operands comprising a one-dimensional array of elements, the vector predicate register can be read to provide a predicate value which controls whether respective lanes of vector processing are masked. Hence, the same register(s) could be shared between indicating vector predicates for vector operations and indicating the masking state data for matrix operations.

At least one masking state addressing register may be provided to store masking state addressing information which identifies locations in memory from which the masking state data can be obtained. For example, when the masking state data is represented using a set of offset values as discussed above, the set of offset values could be stored in memory, and the masking state addressing information in the masking state addressing register could identify where that array is stored in memory. This approach could reduce the number of registers which are architecturally required to be provided for supporting the matrix processing, which may be preferred for some lower power micro-architectural implementations.

Nevertheless, even if it is not architecturally required to provide registers for storing the masking state information itself (as those micro-architectures which do not wish to provide dedicated hardware for storing this information can instead load it when required from memory), some micro-architecture designers may nevertheless choose to provide a masking state cache to cache the masking state data obtained from memory so that it can be accessed more quickly for future accesses, to help improve performance. This can be useful because it may be that the pattern of masked/unmasked rows/columns may be the same for a number of matrix operations, so caching can save a significant number of memory accesses.

Regardless of the form of the masking state data, the load circuitry may determine a target address of the portion of the matrix data structure in memory based on addressing information, which could be defined in various ways. The addressing information could be obtained from a register explicitly referenced by the instruction which causes the load to be performed, or could be obtained from a default register implicitly referenced for the load instruction.

In one example, the addressing information could comprise a set of address pointers, where each address pointer indicates an address of a portion of the matrix data structure corresponding to a respective row or column position of the given operand matrix.

In another example, the addressing information may comprise a base address of the matrix data structure stored in memory and offset information for determining an address of the portion of the matrix data structure corresponding to a given row or column of the given operand matrix relative to the base address. While in some examples this offset information may be represented using the same set of offset values as used for the masking state data, this is not essential and in other examples the offset information may be separate from the masking state data. The offset information could be represented in different ways, e.g. using a stride value which indicates a difference between an address of the portion of the matrix data structure corresponding to one row or column of the given operand matrix and an address of the portion of the matrix data structure corresponding to the next row or column of a given operand matrix, or by explicitly recording the offset for multiple rows/columns in an offset data structure as described earlier. The use of a stride value avoids the need to explicitly encode each separate offset value for the respective rows, but the use of a more explicit offset data structure allows the masking state to be represented in the same structure as the offsets and would permit processing of a matrix with an irregular pattern of memory accesses for the respective rows/columns. Either way, representing the addresses using offset information relative to a base address can allow the addressing information to be represented using fewer bits than if the addressing information indicated the absolute addresses corresponding to each row/column position of the given operand matrix.

In some examples the addressing information could also include further information which provides sub-portion selection information to select which sub-portion of the portion of the matrix data structure in memory identified based on the addressing information is to be loaded to the operand storage circuitry when loading a given target row or column. This recognises that, given limitations on the maximum size of matrices which can be processed in hardware, when processing input matrices of a larger size then the operation may need to be split into a number of sub-operations each acting on a smaller portion of the input matrix. As the layout of matrix data in memory may include rows or columns of a greater size than the block of matrix data to be operated on by a given set of matrix processing instructions, the sub-portion selection information can be used to narrow down which sub-portion of a row or column should be processed for a given operation.

Hence, there are a number of options for representing the addressing information which identifies the location in memory for which a given target row or column is to be loaded. At least one addressing register may be provided to store the addressing information. Prior to executing load instructions or matrix processing instructions, the program being executed may load the at least one addressing register with the appropriate addressing information for selecting the portion of the matrix data structure to be processed.

In some implementations, prefetch circuitry can be provided to generate prefetch requests for prefetching portions of the given operand matrix from memory depending on the addressing information stored in the at least one addressing register. For example, if the addressing information includes an array of offset values then while loading rows or columns of the given operand matrix for earlier rows or columns, the prefetch circuitry could look ahead and start prefetching data based on the offsets for later rows/columns, so that performance is improved. Alternatively, other micro-architectures may prefer not to provide the prefetch circuitry to save power and circuit area.

For some implementations, the first and second input operands for the matrix processing operation may be two-dimensional matrix operands. For example, the matrix processing circuitry may support a full matrix multiply operation being performed in a single instruction, which can be beneficial for performance. However, this approach may be more expensive in terms of power consumption and in circuit area.

Hence, other implementations may prefer to provide matrix processing circuitry which supports performing the matrix processing operation on one-dimensional vector operands to generate a two-dimensional result matrix. For example the matrix processing operation may comprise an outer product operation applied to the 1D vector operands to generate the 2D result matrix. This recognises that in practice a matrix multiplication operation applied to two 2D matrix operands to generate a 2D result matrix can be decomposed into a number of separate outer product operations which are applied to respective combinations of individual rows/columns of the input matrix operands, with the results of the outer product operations being accumulated together to generate the end result equivalent to the 2D matrix multiply result. Hence, it can be particularly useful for the outer product operation to comprise an outer-product-and-accumulate operation, for which the result matrix comprises updated values for respective elements of an accumulator matrix, where the updated value for a given element of the accumulator matrix corresponds to a result of adding a previous value of that given element of the accumulator matrix to a corresponding element of an outer-product result matrix corresponding to a result of performing the outer product operation on the first and second input operands represented as one-dimensional vectors. This operation can be useful for supporting the 2D convolution operations discussed above.

The matrix processing circuitry may generate the result matrix as a two-dimensional matrix based on the first and second input operands, in response to a single instruction. Hence, even if a matrix multiply operation is split into multiple instructions performing separate outer product operations with each outer product operation acting on one-dimensional vector operands, each individual outer product operation may nevertheless generate a two-dimensional result matrix. This may provide improved performance compared to approaches which use vector processing circuitry to perform a series of vector operations equivalent to a matrix operation, where each vector operation processes 1D vector operands to generate a 1D vector result.

### Position Shifting for Matrix Processing

An example apparatus has matrix processing circuitry to perform a matrix processing operation on first and second operands to generate a result matrix, where the result matrix is a 2D matrix. Operand storage circuitry stores information for forming the first and second input operands for the matrix processing circuitry. Position shifting circuitry is provided to apply a variable position shift to vary which row or column of the result matrix is updated based on a given element of one of the first and second input operands stored in the operands storage circuitry during a given matrix processing operation. The variable position shift is based on one of a number of alternative shift amounts selectable for the given matrix processing operation. Each alternative shift amount corresponds to a position shift of the one of the first and second input operands relative to the result matrix by a different number of rows or columns.

The position shifting circuitry is useful for supporting the approach where 2D convolution operations are decomposed into a number of separate 1×1 convolutions accumulating into a result matrix. The inventor recognised that in such a series of 1×1 convolutions, the 1×1 convolution operations corresponding to a number of adjacent kernel positions require very similar input data, but with a relative shift of one or more row/column positions between the inputs for the respective kernel positions. Hence, by providing circuitry to apply a variable row/column position shift of the input to a given matrix processing operation relative to the output, this means that the same operand data loaded from memory can act as inputs for the matrix processing operations for a number of different kernel positions during the series of 1×1 convolutions implementing the 2D convolution operation, which can reduce the number of load operations needed to load data from memory for performing a given 2D convolution operation.

As discussed above, while some implementations could implement full matrix multiplication operations, for limiting the hardware costs other implementations may implement the matrix processing operation as an outer product operation applied to one-dimensional vector operands as the first and second input operands, to generate a two-dimensional result matrix. Hence, in this case the variable position shift may vary which row or column of the result matrix is updated based on a given element within one of the first and second input vector operands. Again, for similar reasons to those discussed above it can be particularly useful for the matrix processing operation to be an outer-product-and-accumulate operation where the result matrix comprises updated values for respective elements of an accumulator matrix, formed based on a previous value for the accumulator matrix and the corresponding elements generated for the outer-product result. This operation can be useful for supporting the 1×1 convolution approach to handling 2D convolutions.

The position shifting circuitry may select between the respective alternative shift amounts based on a parameter specified by a matrix processing instruction for controlling the matrix processing circuitry to perform the matrix processing operation. In some implementations, the parameter identifying the shift amount could be part of the opcode of the matrix processing instruction, so that a number of different opcodes may be allocated for the respective shift amounts, each corresponding to the same type of matrix processing operation (other than having a different shift amount). Alternatively a separate parameter in the instruction encoding could be defined, e.g. a shift amount selection field separate from the opcode identifying the particular matrix processing operation to be performed. The parameter for selecting the shift amount could be represented as an immediate value within the instruction encoding, or could be identified within a register specified by the matrix processing instruction.

Alternatively, in some implementations a certain dedicated register for storing the shift amount selection parameter could be provided, so that the register read in response to the matrix processing instruction to obtain the shift amount selection parameter is implicit, and so does not need explicit encoding in the instruction encoding.

The matrix processing circuitry may also support predication where certain rows or columns within the result matrix can be identified as active or inactive row or column positions as identified by predicate information accessible to the matrix processing circuitry. Hence, when a given row or column of the result matrix corresponds to an active row or column position indicated by the predicate information, then the matrix processing circuitry may generate elements of the given row or column of the result matrix having values depending on a corresponding row or column of one of the first and second input operands (which row or column is the corresponding row or column depends on the one of the alternative shift amounts selected for that particular matrix processing operation). When the given row or column of the result matrix corresponds to an inactive row or column position indicated by the predicate information, then elements of the given row or column of the result matrix are generated having values independent of the corresponding row or column of one of the first and second input operands. For example when a given row or column of the result matrix is inactive then the corresponding elements may retain their previous values without being updated based on the corresponding row or column of the input operand. By providing the ability to prevent certain rows or columns of the input operands affecting the output, this helps deal with the ‘wraparound’ problem discussed above. This predication may be one example of the masking operation described earlier.

Again, as for the masking examples discussed above, the operand storage circuitry may comprise matrix transposition circuitry which enables reading and writing of storage units of the matrix transposition circuitry either in row groups or in column groups. This helps to support more efficient handling of matrix data structures stored in memory represented either in row-major or column-major form. All of the features discussed above for the matrix transposition circuitry may also be provided when the position shifting example is used.

When the matrix transposition circuitry is provided, then the operand storage circuitry may also comprise operand registers for storing the first and second input operands for the matrix processing operation, separate from the matrix transposition circuitry itself. The operand registers may be the storage circuitry from which the operands for a given processing operation are read in response to a matrix processing instructions for controlling the processing circuitry to perform the matrix processing separation.

A dedicated move instruction could be provided to control operand moving circuitry to read out at least one row or column of the given operand matrix from the matrix transposition circuitry and write the at least one row or column to the operand registers. This may simplify the encoding of a matrix processing instruction because any additional parameters for selecting whether a column or a row is to be read from the matrix transposition circuitry (or for selecting which particular row or column should be read) can be encoded in the move instruction so that less encoding space within the matrix processing instruction needs to be expended on such parameters.

However another approach would be that operands could be read out from the matrix transposition circuitry in response to matrix processing instruction and provided directly to the circuit logic for performing the matrix processing operation, without needing to go via a set of operand registers.

While such operand moving circuitry responsive to a move instruction, or the ability to directly read operands from the matrix transposition circuitry were not explicitly described above for the example using masking, these features can also be provided in that example.

Also, the masking functionality described in the earlier section can be combined with the position shifting functionality described above. Hence, even in the position shifting example it is also possible to provide masking circuitry which performs a masking operation based on masking state data as described above.

In fact, it can be particularly useful to combine both the masking functionality on the loads and the position shifting (including the predication applied at the input to matrix processing operation). One may expect that the predication merely would be redundant in the case where the masking on loads is supported, but in fact it can be useful to provide both functionalities. This is because the masking on loads can be used to insert padding values which support padded 2D convolution, even if the predication applied at the input to a matrix processing operation is then further masking to prevent certain rows from affecting the output (to deal with the wraparound problem discussed above). This is because the position of the rows affected by the wraparound problem may differ from kernel position to kernel position so when the position shifting functionality is used to allow multiple kernel positions to be calculated based on a set of data loaded for a single kernel position, then the predication based on the predicate value may be used to select the individual rows to be supressed for each individual kernel position, which would be difficult to handle if such wraparounds were dealt with solely at the point of loading data from memory. Nevertheless the masking approach can be useful for supplying the padding values.

Nevertheless, in the earlier described examples, if the position shifting is not supported then the masking at the point of carrying out a load operation can be sufficient to deal with a wraparound problem if performing a separate load for each kernel position, or alternatively masking on loads may not be supported at all and instead masking/predication may be applied at the time of performing a matrix processing operation.

Again, as for the masking example, the result matrix generated for the matrix processing operation may be a two-dimensional result matrix generated from the first and second input operands in response to a single instruction, so does not require separate processing of individual vector instructions each generating a one-dimensional vector result.

### 2D Convolution

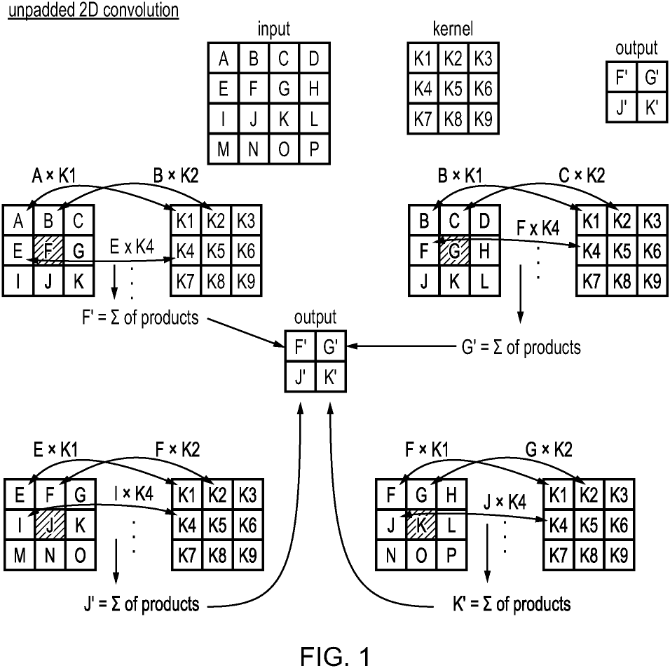

FIG. 1 shows an example of a 2D convolution operation performed on an input matrix and a kernel matrix to generate an output matrix. In this example the input matrix is a 4×4 matrix, the kernel is a 3×3 matrix and the output is a 2×2 matrix. It will be appreciated that it is not essential that the matrices involved are square matrices with the same dimensions for the numbers of rows and columns, and that the particular set of matrix sizes shown in FIG. 1 is just one example.

In the 2D convolution operation, for each output element within the output matrix, the kernel is centred on the element of the input matrix at the corresponding position to the output element being generated, and the output element is generated with a value corresponding to the sum of the products of the respective kernel elements and input matrix elements which are at corresponding positions relative to the centred kernel. For example, for output matrix element F′ which corresponds in position to input element F, the value for F′ is generated by multiplying respective pairs of input and kernel elements which are at the corresponding positions assuming that the central kernel element K5 is positioned over the input element F corresponding to the output position F′. Hence, F′ = A * K1 + B * K2 + C * K3 + E * K4 + F * K5 + G * K6 + I * K7 + J * K8 + K * K9.

Similarly, for each other matrix element within the output matrix, the element is generated based on a sum of products but with the kernel over a different element of the input matrix. For example for output element G′, the kernel matrix has its central element K5 over input matrix element G, which means that the sum of products is G′ = B * K1 + C * K2 + D * K3 + F * K4 + G * K5 + H * K6 + J * K7 + K * K8 + L * K9. Similar operations are performed for generating the output elements J′ and K′.

FIG. 1 shows an unpadded 2D convolution operation, which means that the output elements F′, G′, J′, K′ are generated only for those input positions F, G, J, K where it is possible to centre the kernel on that input position without any kernel element of the kernel matrix extending outside the boundary of the input matrix. For example input elements A, B, C, D, E, H, I, L, N, M, O, P do not have corresponding elements in the output matrix because this would require part of the kernel to extend outside the boundary of the input matrix. Hence, for an unpadded 2D convolution the output may generally be smaller than the input.

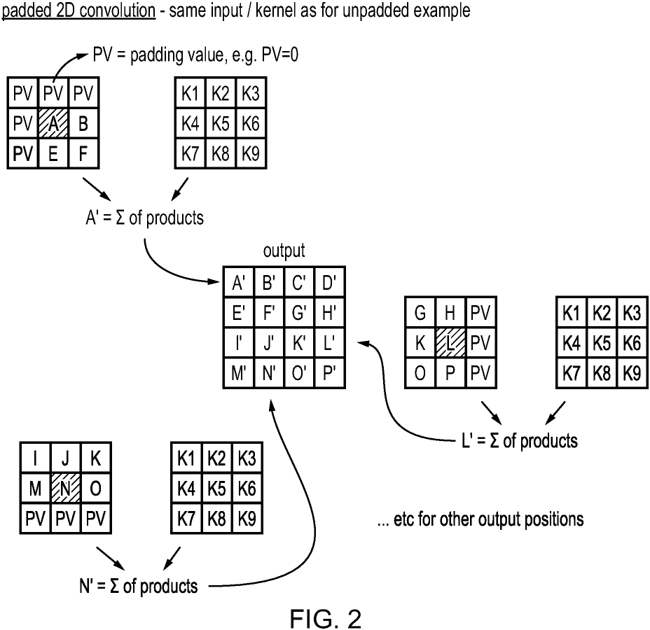

As shown in FIG. 2, it is also possible to perform a padded 2D convolution where the output matrix is generated with the same dimensions as the input matrix, by supplying padding values (PV) for the element positions outside the boundaries of the input matrix which would be needed to apply the kernel centred on the positions near the edges of the input matrix. In the example of FIG. 2, the input matrix and the kernel may be the same as in FIG. 1, but this time the output matrix is also a 4×4 matrix which, in addition to elements F′, G′, J′ and K′ which are calculated in the same way as FIG. 1, also comprises the surrounding elements A′ to P′ to bring the output matrix to the same side as the input matrix.

For the calculations when the kernel is centred on one of these outer element positions, then the kernel elements which would sit outside the input matrix are multiplied with padding values (PV). For example, for the calculation for generating output element A′, this would require the central kernel position K5 to sit over element A of the input matrix, and so while there are valid input values for positions A, B, E, F in the input matrix corresponding to kernel elements K5, K6, K8, K9, the other kernel elements K1, K2, K3, K4, K7 are multiplied with padding values when generating the sum of products to generate the new value for output matrix A′.

Similarly, for other elements around the boundary of the output matrix, the padding values will be in different positions relative to the kernel, depending on the edge of the input matrix at which that kernel is overlapping. For example, for output position L′ the padding values will be needed for the right hand column of the kernel K3, K6, K9 as these are the positions which would extend outside the input matrix when the kernel is centred over position L. Similarly, for output element N′ then kernel position K5 will be centred on position N and so this means that the bottom row of kernel positions K7, K8, K9 extends outside the input matrix and so requires padding.

In one example, the padding value could simply be zero. However, some 2D convolution operations may require other types of padding values. For example in some cases a quantization scheme could be used where an offset is applied to the true values of the matrix when generating the stored numeric values for each matrix element, so that ‘zero’ may actually be represented using a non-zero numeric value. In this case, the padding value may be a non-zero value representing the zero point. The padding values may be set based on averaging of other elements within the input matrix. The precise rules for setting the padding values may depend on the particular application being performed. Hence, it can be useful to support the ability to select between the number of alternative types of padding value (e.g. based on a control register and/or a parameter specified by a matrix processing instruction).

While not shown in the example of FIGS. 1 and 2, it is also possible to do strided convolutions in which the kernel values, when centred on a given input element, are applied to neighbouring input elements separated from the central input element by intervals of a constant stride (in contrast to FIGS. 1 and 2 where the stride is 1, other examples could have a stride of 2 or more).

Unpadded and padded 2D convolution operations can be useful for a range of processing applications. For example, 2D convolutions can be useful for applying filters to images, for example for blurring, sharpening, edge detection, etc. The kernel applied may be selected based on the type of filter desired, and may have particular values for the kernel elements which will bring out some features such as edges. Effectively the kernel may slide over each successive image pixel and apply an operation to generate a new value for an output pixel based on that pixel and a number of surrounding pixels using the relationship defined by the kernel.

Another type of processing which may include 2D convolutions is in the field of machine learning, for example in implementing neural networks. For example, a neural network trained to detect features within image data could be implemented using a set of kernels which are applied to the image data in 2D convolution operations. More generally, feature maps representing some data to be processed can be processed with kernels in order to make inferences about the data.

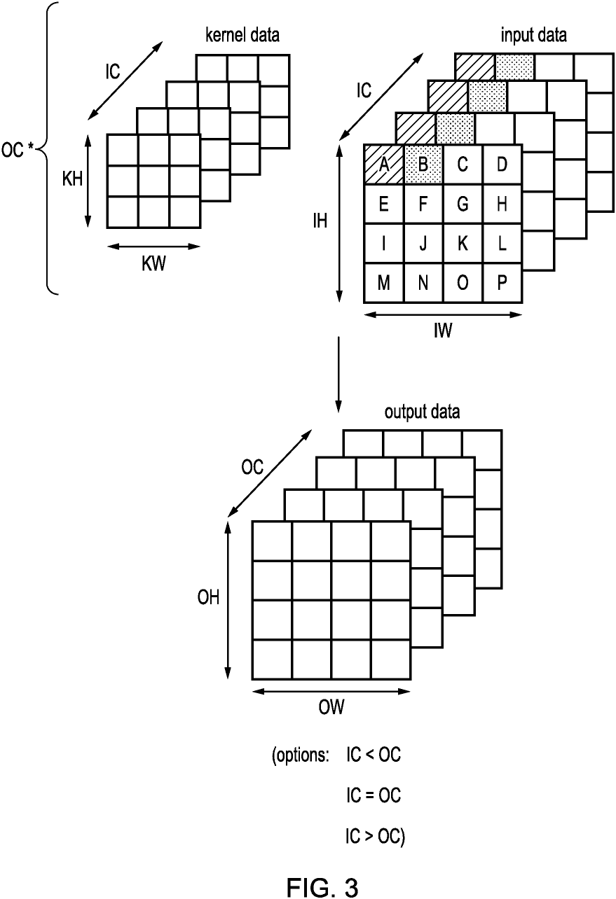

As shown in FIG. 3, for machine learning algorithms, to enable a number of different inferences to be derived from a set of data it can be useful to support multiple channels of input and output data and multiple sets of kernel weights. Each input/output channel may comprise a two-dimensional matrix of elements. For example the number of input channels may be IC, and the height and width of each input channel may be IH (Input Height) and IW (Input Width). The number of output channels is OC, and the height and width of each output channel may be OH (Output Height) and OW (Output Width). OC sets of kernel weights are provided, where OC matches the number of output channels. Each set of kernel weights comprises KH*KW*IC weights (where KH and KW are the kernel height KH and kernel width KW and IC is the number of input channels). A given output channel is generated by performing IC instances of the basic 2D convolution operation of the type shown in FIGS. 1 or 2, each instance combining a single input channel IC with a corresponding sub-set of KH*KW kernel weights, and accumulating the results of the basic 2D convolutions for each input channel together to generate the corresponding output channel (or by performing other sequences of operations which give the same result, as will be described later). The other output channels are calculated using similar operations but using a different set of KH*KW*IC kernel weights for each output channel. Whether or not OH and OW are the same or smaller than the input height IH and input width IW may depend on whether padded or unpadded 2D convolutions are being performed.

In this example, the number of output channels OC is equal to the number of input channels IC, but this is not essential. Other examples could have different numbers for IC and OC. Also, the 2D convolution shown in FIG. 3 may be just one step in a tree of 2D convolutions, so the input channels could themselves be formed as the output from earlier convolutions, and the output channel in FIG. 3 could themselves be processed by further convolutions.

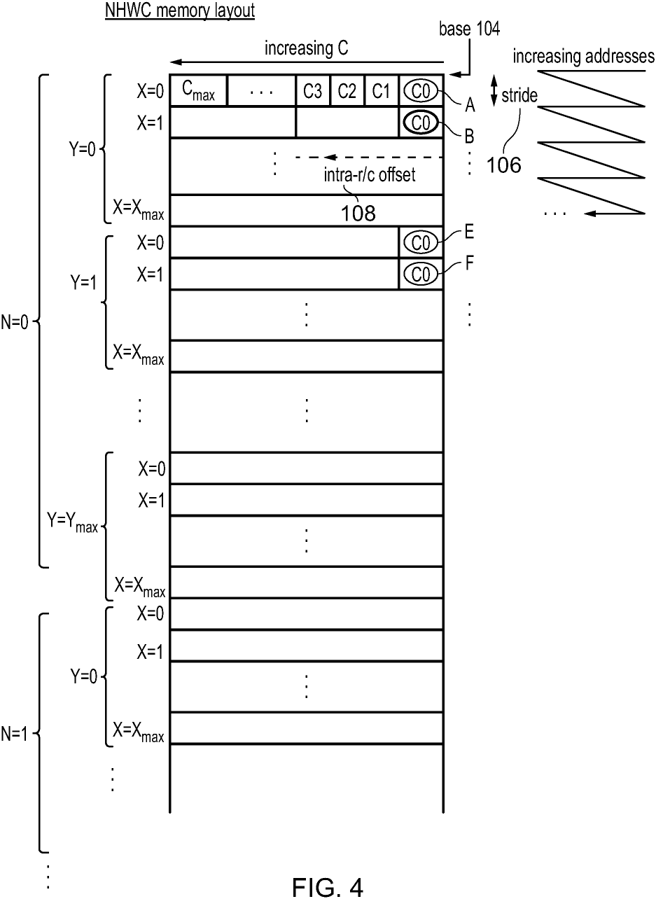

When 2D convolutions are to be applied to a number of input channels then there may be a number of choices for the layout used to store the data of the input channels within memory. FIG. 4 shows one possible memory layout, referred to as the NHWC memory layout, where C refers to input channels, W refers to the width, H refers to the height and N refers to a number of distinct objects represented by separate sets of IC input channels. The NHWC notation indicates that when reading data from successive addresses within a data structure in memory, the input channel identifying variable C is the fastest changing variable and the object identifying variable N is the slowest changing variable. Hence, in NHWC layout, when traversing through successively increasing addresses within the data structure in memory, first the input matrix elements for a given x-y matrix position for each of the IC input channels is stored in a continuous block of addresses within memory, then the elements within each input channel for the next position within the same row as the first matrix elements are laid out, and so on for each other x-y position. That is, the elements first cycle through all the input channels for one element position, and then move to the next element in the same row (as the width W is the next fastest changing variable after the channel ID), and then once all the locations in the same row (elements having the same y matrix coordinate) have been stored for all of the channels then the next element stored will be for the next row at the next highest y position.

Hence, when referring to FIG. 3, the first row of a memory layout shown in FIG. 4 may correspond to the elements within the cross hatched boxes which correspond to position A within each input channel then the next row may correspond to the element shown with dotted shading which correspond to position B within each input channel, and so on for the rest of the elements C, D within that first row. Once the end of the row has been reached then the same is done for the next row starting with the elements at position E within each input channel. Where multiple objects to be processed (e.g. a number of separate images) are each represented using a separate set of IC input channels, then all the data for one object (N=0) is stored in memory prior to the data for the next object (N=1).

It will be appreciated that while for ease of understanding FIG. 4 shows the elements for a given input matrix position in all the channels in one “row” of the address space and then moves onto the next “row” of the 2D representation of FIG. 4 for storing the elements at the next input position B, in practice the address space is simply a monotonically increasing series of addresses and there is no 2D arrangement of addresses as shown in FIG. 4. The 2D representation shown in FIG. 4 is a graphical representation used for conciseness to fit the information onto the page. Nevertheless the information stored in memory represents multiple channels of matrices, where those matrices are two-dimensional structures arranged logically in rows and columns.

The NHWC memory layout shown in FIG. 4 is one possible layout, but other implementations could store the matrix structure in a different layout. For example if the NCHW memory layout is used then the layout may provide all the X/Y values for channel 0, then all the X/Y values for channel 1, and so on.

Regardless of the particular memory layout selected for a given application, one problem with the 2D convolution approach is that the elements which are required for combining with the kernel elements for generating a given output element within the output matrix may not be within contiguous memory addresses within the memory address space. For example, for calculating the top left output position A′ in the padded 2D convolution of FIG. 2, this may require input elements for positions A, B, E, F to be obtained from memory, but as shown in FIG. 4 when stored in an NHWC memory layout these are not within contiguous portions of the address space as they are separated by elements for input positions C and D. Each kernel position may require a different bespoke subset of the elements to be extracted from the data structure defining the input matrix in memory.

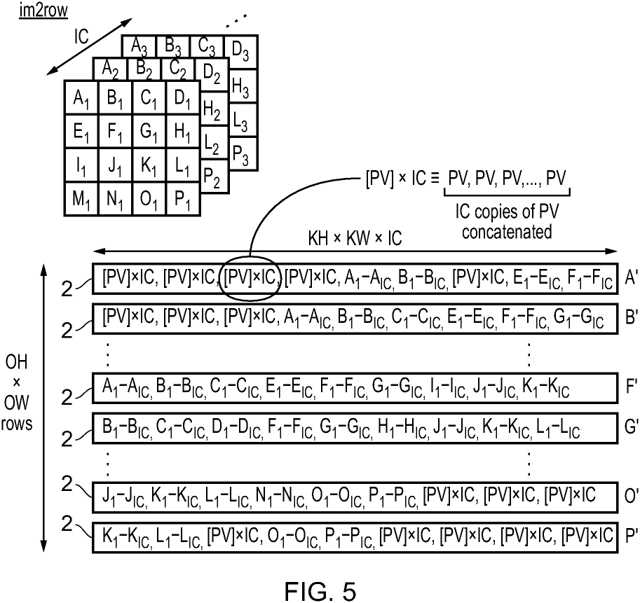

FIG. 5 shows one approach, called im2row, for dealing with this problem. In im2row, prior to performing the 2D convolution operations itself, the input matrix structure representing the input channels is first rearranged to generate a number of rows 2 of data stored in a different part of the address space from the original input data structure, where each row 2 corresponds to the data which will be operated upon by the kernel matrix for a particular output element position in the output matrix. For example, for output position A′, the required elements A, B, E, F of the respective input channels can be gathered together, and combined with appropriate padding so that they are in the correct positions corresponding to the order of the kernel elements K1 to K9. This means a subsequent matrix processing operation can simply multiply each kernel element of multiple kernel channels with the corresponding data at the matching position within the row 2, and add the resulting products to generate the data for that output position. Note that a given row 2 has the respective input values for each of the input channels IC located adjacent to each other and these would be operated on by respective kernel values for the same kernel position within different kernel channels.

Similarly, for each other output position within the output matrix, a different row 2 is generated by gathering together the respective input elements needed to generate that output position. Hence, this requires OH * OW rows 2 of additional data to be generated where each row comprises KH * KW* IC elements. While this may generate a lot of overhead in extracting the respective subsets of elements from the data stored in memory and copying them elsewhere in memory to generate the rows, this can greatly simplify the subsequent 2D convolution operation which can then simply apply the kernel values directly to a contiguous block of memory in a matrix processing operation to generate the corresponding output matrix.

However, this approach has several problems. One problem is that increasingly performance is improving for matrix processing operations implemented in a given data processing system. As matrix processing performance improves, Amdahl’s Law means that other operations performed alongside the matrix processing operations themselves have an increasingly important impact on overall performance. Even if the matrix processing operations themselves can continue to improve in performance, if other operations such as the im2row operation shown in FIG. 5 are not able to show a similar performance improvement to the matrix processing operations (as the im2row operation is memory bandwidth bound), then the full benefit of the performance improvements in the matrix processing cannot be realised. Hence, the overhead of performing im2row as shown in FIG. 5 is increasingly unacceptable for some processing applications. Another problem is that these remapping operations consume a lot of memory. For example, note that the input matrix elements for position F are shown within multiple rows 2 in the example of FIG. 5. Hence, this also wastes memory address space due to the duplication of input values merely to provide the appropriate relative positioning of the input matrices relative to the kernel matrices. For example, im2row may require as much as 8-9 times as much memory as the original input data structure for some machine learning algorithms.

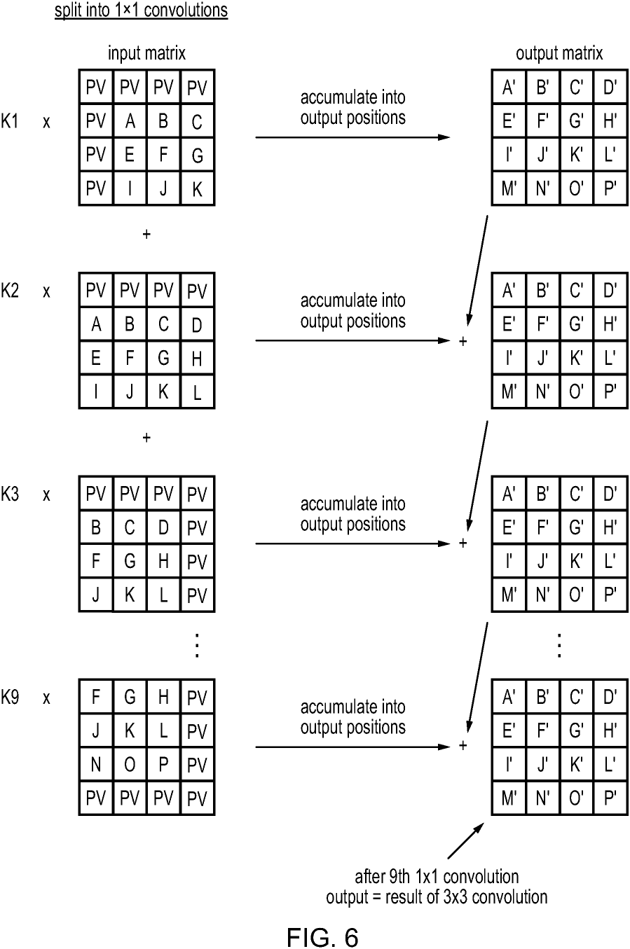

Another type of convolution operation is a 1×1 convolution operation, which is similar to the 2D convolution described above but with a kernel which is a 1×1 matrix instead of having a 2-dimensional extent. With a 1×1 kernel, the result of a 1×1 convolution operation is simply an output matrix in which each element corresponds to the result of multiplying a corresponding element of the input matrix by the same kernel element. As shown in FIG. 6, by using a series of 1×1 convolutions it is possible to generate the same result as a 2D convolution, by accumulating the results of a number of 1×1 convolutions with a relative shift of the position at which the result of a given 1×1 convolution operation is added to the results from previous 1×1 convolution operations.

In the examples of the 2D convolutions shown above, the calculation of the sum of products has been shown separately for each position of the output matrix, with each group of products being for different pairs of input/kernel positions but the same output position.

However, it is also possible to partition the multiplications in a different grouping, considering the set of multiplications associated with a single kernel position as a group, with that group of multiplications generating one of the products to be summed for each output position. Considering the example of FIG. 2, say, when considering a single kernel position, e.g. position K1, that kernel value K1 needs to be multiplied by a padding value when generating output value A′, multiplied by input value G when generating output value L′ and multiplied by input value I when generating output element N′. Hence, the top part of FIG. 6 shows the relationship between the input elements to be multiplied by K1 to form one partial product used in the sum for each of the corresponding output elements A′ to P′ in the output matrix.

Similarly, for each other kernel position K2-K9, it can be determined which input element (or a padding value) should be multiplied with that kernel element to generate another of the products summed for each of the output positions. Note that a given input matrix element contributes to a different element of the output matrix for each kernel position. For example, when considering input element F, this will contribute to output element K′ when multiplied with kernel element K1, contribute to output element J′ when multiplied with kernel element K2, contribute to output element I′ when multiplied with kernel element K3, and so on, until F contributes to output element A′ when multiplied with kernel element K9.

Therefore, between respective kernel element positions, there is a relative shift between the position of a given output element in the output matrix and the position of the corresponding input element that contributes to that given output element for that particular kernel element position. For instance, the shift of the effective input matrix between the K1 multiplication and the K2 multiplication is a shift left by one column position.

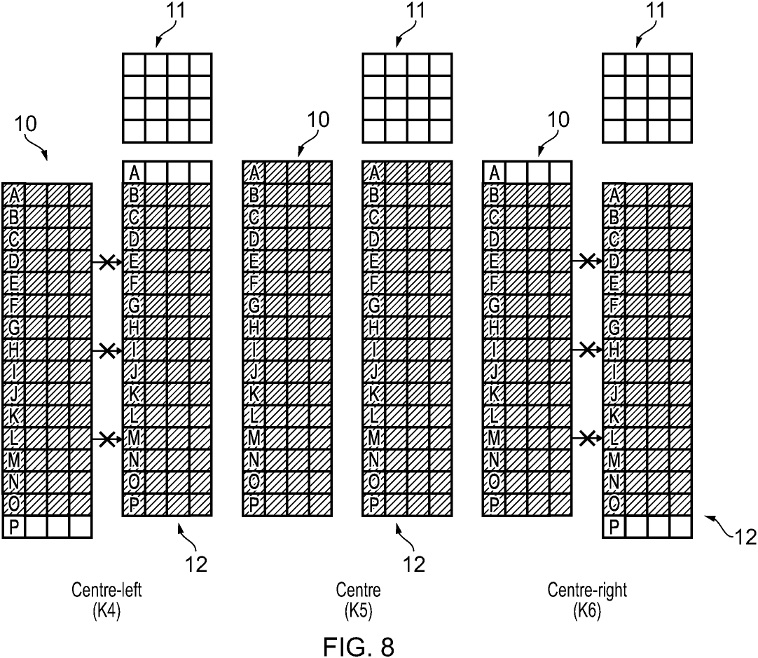

This means that, by performing a series of 1×1 convolutions and accumulating the results of each 1×1 convolution into an accumulator matrix representing the running totals for the output matrix, the result can be equivalent to the result of the 2D convolution operation performed over a kernel size larger than 1×1. For example, the result of each of the K2 multiplications shown may be added to the corresponding elements of the accumulator matrix resulting from the K1 multiplications (with, say, the result of K2*B being added to the accumulator matrix element at position F′ set based on K1*A in the K1 1×1 convolution), and the result of each of the K3 multiplications may then be added to the corresponding elements of the accumulator matrix resulting from the K1 and K2 multiplications (with the result of K3*C being added to the accumulated value for output element F′ so that F′ now equals K1*A + K2*B + K3*C). This continues for each successive kernel position, and so by the end of the ninth 1×1 convolution operation, the output matrix has the same result as if the 2D convolution operation had been performed with a 3×3 kernel matrix. It will be appreciated that it is not essential to calculate the 1×1 convolutions in the order K1, K2, K3, ... , K9 shown in FIG. 6, and any order of kernel points may be used. However, if the position shifting example is used as described below, then calculating neighbouring kernel positions in succession may help to improve performance as the shifts between the input positions used to calculate a given output position for successive 1×1 convolutions will be smaller and so this can facilitate more frequent reuse of data loaded from memory across multiple 1×1 convolutions when the variable position shifting technique described below with respect to FIG. 8 is used.

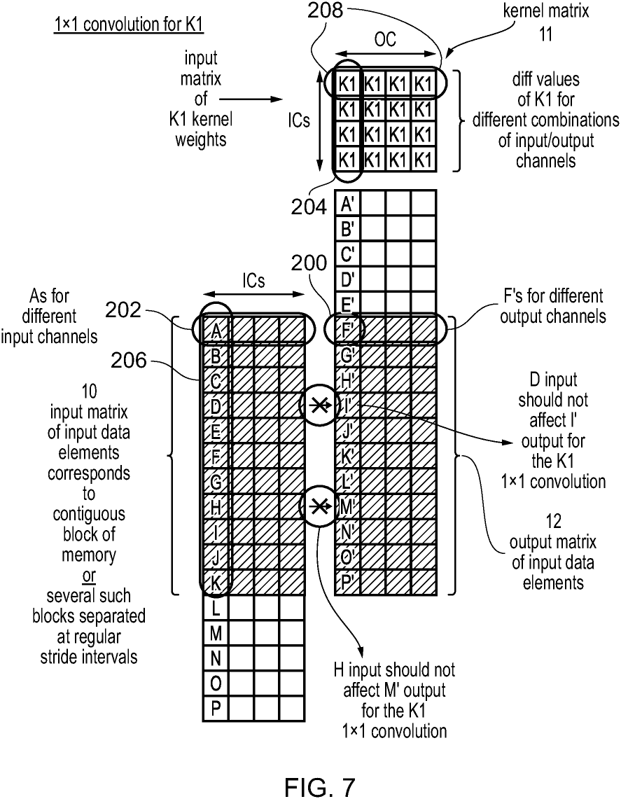

As shown in FIG. 7, an advantage of using the split 1×1 convolution approach shown in FIG. 6 is that this means that the multiplications required for a given kernel position Kn can be applied to data loaded from a block of memory which is either a single contiguous block of memory, or several such contiguous blocks separated at regular stride intervals, which means that the 1×1 convolution operations can be applied directly to data in a similar format to the data structures in memory, and the performance-intensive and memory-hungry im2row technique shown in FIG. 5 is not needed.

FIG. 7 shows how the 1×1 convolutions can be expanded to handle multiple input and output channels similar to the earlier examples. FIG. 7 shows a matrix multiplication operation for calculating the set of products corresponding to a single kernel position in the x-y dimension, e.g. kernel position K1 in the example of FIG. 7. That is, FIG. 7 shows the calculation of the products for the top portion of FIG. 6 only, but expanded to handle multiple input/output channels. It will be appreciated that similar operations may then be performed for each other kernel position.

FIG. 7 shows an example for implementing part of a 2D convolution operation for which there is crossover between input channels to generate each output channel (that is, the results of the 2D convolution applied to each pair of kernel/input channels would be added to give the matrix for a given output channel). This means that for the 1×1 convolution corresponding to a given kernel point K1, the value at a given position F′ in a given output channel corresponds to the sum of products ΣK1ᵢ ∗ Aᵢ, where i is incremented across all input channels and K1ᵢ is the kernel value at a corresponding position within each kernel channel and Aᵢ is the input element at a corresponding position within each input channel. A corresponding operation can be performed in parallel for a number of different sets of kernel channels (to allow multiple features to be detected in parallel), to generate multiple output channels.

Hence, as shown in FIG. 7, the 1×1 convolution for a given kernel position K1 when evaluated across multiple input/output channels can be expanded to be a matrix multiplication operation which multiplies an ZxIC input matrix 10 providing a set of Z input element values A to K for each of the IC input channels by an ICxOC kernel matrix 11 providing the set of kernel values for kernel position K1 for each IC input channel within each of the OC sets of distinct kernel channels corresponding to the respective output channels. The result of the matrix multiplication is then a ZxOC output matrix 12 providing, for each output channel OC a set of Z output elements F′ to P′. Note that the Z dimension for the input/output matrices 10, 12 will vary depending on which kernel position Kn is being processed, as for K1 the range of non-padded element positions needed extends from A to K, but for a different element position (e.g. K2) the range of non-padded element positions may be larger (e.g. extending from A to L). Also, if a non-zero padding value is being used, then additional matrix rows may be needed in the input/output matrices to accommodate the non-zero padding.

The input matrix 10 can be loaded from memory direct from the data structure laid out as shown in FIG. 4, because each row of input matrix 10 includes a set of elements for a single x-y position within the input matrix across each of the IC input channels. For example the top row of the input matrix 10 provides the “A” elements for each of the different input channels (e.g. x=0, y=0), then the next row of input matrix 10 provides all the “B” elements (x=0, y=1), and so on. Hence, if the data is laid out in memory in NHWC layout as shown in FIG. 4, this input matrix 10 simply corresponds exactly to the format of the data stored in the memory, and so can be loaded as a single contiguous block of memory. Alternatively, if the number of input channels IC that can be processed in one operation by the processing hardware is smaller than the actual number of channels Cₘₐₓ used in the matrix structure stored in memory, then the input matrix 10 could correspond to a number of discontiguous chunks separated at intervals of constant stride, which is still much simpler to load from memory than if 2D convolutions were performed in the manner shown in FIG. 2 which would require a number of irregular patterns of memory accesses as shown in the im2row example. Hence, the 1×1 convolution approach means that no remapping of the matrix structure stored in memory is needed before performing the multiplications for calculating the 1×1 convolution.

Similarly, the output matrix 12 has a corresponding layout to the input matrix 10, and so once all the 1×1 convolutions for the 2D convolution have been accumulated together, the result can be written directly back to a matrix data structure in memory laid out as in FIG. 4.

As shown in the top part of FIG. 6, when considering the top left kernel weight K1, the relative shift between input positions and output positions is such that row A of the input matrix should be multiplied with the kernel weight K1 to generate outputs for row F of the output matrix, row B of the input matrix contributes to row G of the output matrix, and so on. This generally works for most rows, as there is a constant shift of position of 5 rows downwards between input and output matrices for the K1 weight example. However, there are some rows D, H of the input matrix for which multiplying these rows by the kernel weights and accumulating the results into the corresponding shifted positions I′, M′ of the output matrix would give the wrong results, because as shown in FIG. 6 this would mean that an element at the far left of the output matrix would be updated based on multiplications using an element on the opposite right hand edge of the input matrix, which is incorrect for a 2D convolution. This problem may be referred to as a “wraparound” problem. While the wraparound problem could be avoided by splitting the matrix multiplication between matrices 10 and 11 shown in FIG. 7 into a number of separate operations each corresponding to a chunk of input matrix 10 which only includes a block of rows A-C (or E-G or I-K) where all of those rows do need to contribute to the output matrix, this would require additional instructions to be executed and would reduce performance.

Therefore, to allow the 1×1 convolutions to be applied over a larger number of rows even if there are selected rows which encounter the wraparound problem, it can be useful to support a masking operation which allows certain rows of the input can be skipped when generating the output. This is shown by the “X” marked on the path between inputs rows D, H and output rows I′, M′. The masking operation may be controlled by masking state data which defines the positions of the masked rows (or if the matrices are instead arranged with the input elements for a given input channel position extending within the same column, the masked columns). Examples of encoding the masking state data are described below. The masking operation could be implemented at the time of loading the data from memory into registers (so that instead of loading the actual data elements from memory, a masking value is instead loaded into corresponding portions of the operand storage for storing information for forming the input channel matrix 10). Alternatively, the masking operation could be performed at the time of performing the matrix processing operation itself, so that when the matrix processing circuitry reads operands for processing, predication is applied to mask out a read row of elements and ensure that the matrix processing circuitry treats those elements as if they represented the masking value instead of the actual value stored in operand storage. The masking value could be zero, or could be non-zero if a zero point is represented using a non-zero value. Either way, this means that the wraparound problem is prevented from causing errors and this enables a 1×1 convolution to be performed in fewer instructions as the 1×1 convolution can be applied to a matrix size larger than the block of contiguous rows that does not encounter the wraparound problem.

For the other kernel weight positions K2-K9, similar matrix multiplication operations to that shown in FIG. 7 for K1 can be performed, with the results being accumulated together.

FIG. 8 shows a further observation which can be used to improve performance by reducing the number of times data needs to be loaded from the matrix data structure in memory for performing the 1×1 convolutions for a series of kernel weight positions. It is observed from FIG. 6 that when evaluating the respective 1×1 convolutions for different kernel positions within the same row, the input matrix needed for each of those kernel positions is very similar. For example, FIG. 8 shows the input matrices 10 for the centre-left, centre and centre-right kernel positions K4, K5, K6 respectively. For the central kernel weight K5, the input matrix will be exactly aligned with the output matrix as kernel weight K5 is multiplied by position A when generating output A, with position B when generating output B, and so on for each of the other positions in the input/output matrices 10, 12.

For the centre-left kernel position K4, K4 needs to be multiplied with element A of the input matrix when generating output element B (because K4 will be multiplied by A when the central position of the kernel K5 is over element B). Similarly, there is a 1 position shift between input elements and output elements for each of the other positions within the input/output matrices 10, 12.

Similarly, for the centre-right kernel position K6 needs to be multiplied with input element B to generate output element A, with input element C to generate output element B, and so on.

As shown in FIG. 8, for the centre-left and centre-right positions there are some rows to be skipped due to the wraparound problem described with respect to FIG. 7 and the specific positions of the skipped rows varies depending on the kernel weight position (e.g. the skipped input rows are rows D, H, L for K4 but are rows E, I, M for K6, and for K5 there are no skipped input rows).

However, it can be seen that in general the input data for rows A-P of the input matrix 10 is essentially the same for each of the three kernel weight positions K4, K5, K6, except that relative to the centre position K5, for the centre-left position K4 the input matrix 10 is shifted down one row position relative to the output, so that input row A is used to generate output row B instead of generating row A as in the central position K5. Similarly for the centre-right position the input matrix 10 is shifted up one row relative to the output matrix 12 so that input row B feed into output row A.

Therefore, it is observed that by providing circuitry which performs a variable position shift of the inputs relative to the outputs, so that it can be adjusted which row of the output matrix is updated based on a particular row of the input matrix, and which supports multiple different alternative shift amounts that can be selected, this enables a block of matrix data loaded from memory to be reused for the 1×1 convolutions for multiple different kernel positions. This means the memory bandwidth associated with the loads for loading input rows A-P can be amortized across multiple different matrix processing operations, which greatly improves performance. If this position shifting is used, then as the positions of the masked rows for dealing with the wraparound problem vary from kernel position to kernel position, then the masking would be needed at the point of reading the previously loaded operands from registers or a matrix transposition box.

### Data Processing Apparatus Supporting Matrix Processing

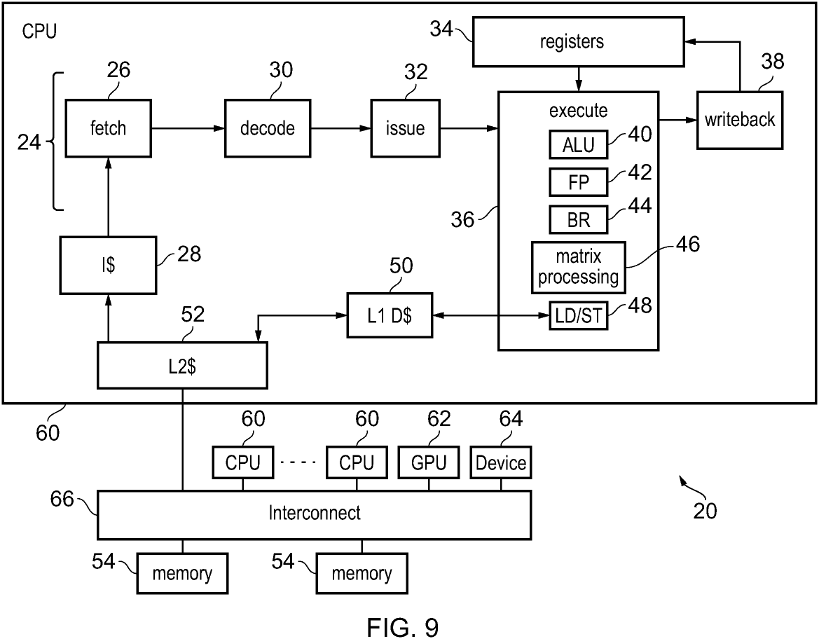

FIG. 9 schematically illustrates an example of a data processing apparatus 20. The data processing apparatus has a processing pipeline 24 which includes a number of pipeline stages. In this example, the pipeline stages include a fetch stage 26 for fetching instructions from an instruction cache 28; a decode stage 30 for decoding the fetched program instructions to generate micro-operations to be processed by remaining stages of the pipeline; an issue stage 32 for checking whether operands required for the micro-operations are available in a register file 34 and issuing micro-operations for execution once the required operands for a given micro-operation are available; an execute stage 36 for executing data processing operations corresponding to the micro-operations, by processing operands read from the register file 34 to generate result values; and a writeback stage 38 for writing the results of the processing back to the register file 34. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 34.

The execute stage 36 includes a number of processing units, for executing different classes of processing operation. For example the execution units may include a scalar arithmetic/logic unit (ALU) 40 for performing arithmetic or logical operations on scalar operands read from the registers 34; a floating point unit 42 for performing operations on floating-point values; a branch unit 44 for evaluating the outcome of branch operations and adjusting the program counter which represents the current point of execution accordingly; a matrix processing unit 46 for matrix processing (which will be discussed in more detail below); and a load/store unit 48 for performing load/store operations to access data in a memory system 28, 50, 52, 54.

In this example, the memory system includes a level one data cache 50, the level one instruction cache 28, a shared level two cache 52 and main system memory 54. It will be appreciated that this is just one example of a possible memory hierarchy and other arrangements of caches can be provided. The specific types of processing unit 40 to 48 shown in the execute stage 36 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

In some implementations the data processing apparatus 20 may be a multi-processor apparatus which comprises a number of CPUs (central processing units, or processor cores) 60 each having a processing pipeline 24 similar to the one shown for one of the CPUs 60 of FIG. 9. Also the apparatus 20 could include at least one graphics processing unit (GPU) 62, and/or other master devices 64 which may communicate with one another and with the CPUs via an interconnect 66 used to access memory 54.

One approach for supporting matrix processing operations can be to decompose the individual multiplications of a given matrix processing operation into separate integer or vector instructions which can be processed on the processing pipeline 24 of a given CPU 60. However, this may be relatively slow.

Another approach to accelerating matrix processing can be to provide, as one of the devices 64 connected to the interconnect 66, a hardware accelerator with dedicated hardware designed for handling matrix operations. To interact with such a hardware accelerator, the CPU 24 would execute load/store instructions using the load/store unit 48, to write configuration data to the hardware accelerator defining the matrix operands to be read from memory by the hardware accelerator and defining the processing operations to be applied to the operands. The CPU can then read the results of the matrix processing back from the hardware accelerator using a load instruction specifying an address mapped to registers within the hardware accelerator. While this approach can be faster than using integer operations within the pipeline, there may nevertheless be an overhead associated with using the load/store mechanism to transfer information between the general purpose processor 60 and the hardware accelerator 64, and also the hardware accelerator approach can create challenges when different virtual machines running on the same processing system need to share access to the hardware accelerator. Therefore, this approach may not scale well in a virtualised implementation having a number of virtual machines.

Therefore, as shown in FIG. 9, it is possible to provide matrix processing circuitry 46 within the regular processing pipeline 24 of a given CPU 60 which can be controlled to perform matrix processing in response to matrix arithmetic program instructions decoded by the decode stage 30 of the pipeline (similar to controlling regular integer or floating point arithmetic operations using the ALU 40 or the floating point unit 42). This avoids the need to transfer data backwards and forwards between the CPU 60 and the hardware accelerator and makes it much simpler to allow a number of different virtual machines to perform matrix operations.

While FIG. 9 shows a multi-processor apparatus 20 having several CPUs 60, this is not essential and the matrix processing circuitry 46 could also be implemented in a single-core system.

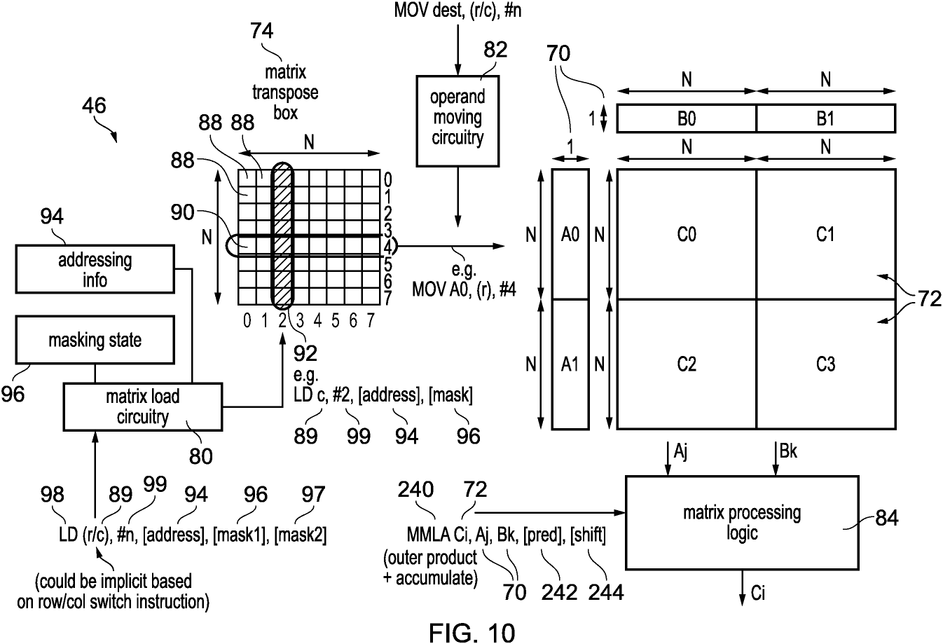

FIG. 10 shows in more detail a portion of the matrix processing circuitry 46 and associated registers for supporting the matrix processing. The matrix processing circuitry 46 may include operand storage circuitry including sets of input operand registers 70, sets of output matrix registers 72 and matrix transposition circuitry 74 (hereafter referred to as a matrix transpose box). Also, the matrix processing circuitry includes matrix load circuitry 80 for handling loading of data from matrix structures in memory into the operand storage circuitry 70, 74, operand moving circuitry 82 for moving operand data between the matrix transpose box 74 and the input operand registers 70, and matrix processing logic circuitry 84 for performing the matrix processing operations themselves on input operands stored in the input operand registers 70 to generate two-dimensional result matrices stored in output matrix registers 72.

The matrix transpose box 74 includes a number of storage elements 88 each for storing a different matrix element of a given operand (input) matrix. The storage elements 88 are logically arranged in rows and columns so that they are accessible either as a row group 90, where all of the storage elements 88 which correspond to the same row of the input matrix are readable/writable, or as a column group 92 where all of the storage elements 88 which correspond to the same column of the input matrix are readable/writable. The physical arrangements of the storage elements 88 on the integrated circuit does not need to follow the logical arrangement in rows and columns and can take any physical arrangement. The ability to read or write the elements 88 in row groups 90 and column groups 92 is provided instead by providing read/write ports and multiplexing circuitry so that the relevant elements which correspond to a given row or a given column can be read, regardless of their physical location in the chip.

This means that when loading data from a matrix data structure in memory, the matrix load circuitry 80 may select (in response to a row/column direction selection parameter 89) whether to load an individual row group 90 of the matrix transpose box 74 or an individual column group 92 with data from a portion of the matrix structure in memory selected based on addressing information 94. A load instruction 98 decoded by the instruction decoder 30 to control the matrix load circuitry 80 may specify a row/column ID 99 which identifies which particular row or column is to be loaded. The instruction could specify the row/column ID 99 directly as an immediate parameter, or indirectly by specifying a register which contains the row/column ID 99.

The row/column selection parameter 89 could be explicitly encoded in the load instruction 98, using a field within the instruction encoding which selects whether a row group 90 or a column group 92 of the matrix transpose box 74 is loaded with data from memory. Alternatively, the row/column direction selection parameter could be implicitly encoded. For example, there may be a control parameter stored in a control register which specifies whether the matrix load instructions 98 should currently select that rows of the matrix transpose box 74 should be loaded or that columns should be loaded. The control parameter in the control register could switch states when a row/column direction switching instruction is executed. This avoids the need for every matrix load instruction to specify an explicit row/column direction selection parameter. Also, it is possible to use both a parameter specified in the instruction encoding and a parameter stored in a control register, with the combination of the control register bit and the row/column selection bit in the instruction encoding selecting which of the row/column directions is used. For example, the control register bit could indicate whether rows/columns are selected, but the bit in the instruction encoding could select whether the bit in the control register is inverted or not, e.g.:

| Row/column selection bit in control register (0=row, 1=column) | Direction flip bit in instruction (0=unflipped, 1=flipped) | Select row/column direction? |
|---|---|---|
| 0 | 0 | Row |
| 0 | 1 | Column |
| 1 | 0 | Column |
| 1 | 1 | Row |

Of course, other encodings could be used instead - this is just one example.

Also, the load circuitry 80 is responsive to masking state information 96, 97 to select whether or not to replace the values loaded into the matrix transpose box 74 with masking values instead of the values loaded from memory. In this example, the masking state information includes first masking state information 96 and second masking state information 97.

The first masking state information 96 is used to control masking of certain row/column positions to prevent the corresponding row/column group of the matrix transpose box 74 being updated based on the corresponding values of memory. For each row/column position in the matrix transpose box 74, the first masking state information 96 identifies whether that row/column position is a masked row/column position or an unmasked row/column position. That is, if the row/column selection parameter(s) 89 indicate that elements are to be written in rows, the masking indications of the first masking state information correspond to different row positions. If the row/column selection parameter(s) 89 indicate that the elements are to be written to the matrix transpose box 74 in columns, then the masking indications of the first masking state information correspond to different column positions.

If the first masking state information 96 specifies that the target row/column to be loaded is an unmasked row/column, then the second masking state information 98 can be used to identify which individual element positions within the target row/column are masked, and the matrix load circuitry 80 obtains the corresponding data from the matrix structure stored in memory and writes the non-masked elements of the target row/column to the corresponding elements 88 of the selected row/column group of the matrix transpose box 74 (with any masked out elements in the selected row/column group being set to the masking value instead). Hence, the second masking state information 98 may provide a set of masking indications where each masking indication corresponds to a different position extending in the opposite dimension to the positions associated with the masking indications of the first masking state information. That is, if the row/column selection parameter(s) 89 indicate that elements are to be written in rows, the masking indications of the second masking state information correspond to different column positions. If the row/column selection parameter(s) 89 indicate that the elements are to be written to the matrix transpose box 74 in columns, then the masking indications of the first masking state information correspond to different row positions.

The first and second masking state information 96, 97 together represent two-dimensional masking state information as they indicate positions of masked elements across two dimensions of the matrix to be loaded into the matrix transpose box 74. However, each individual instruction only uses the part of the first masking state information corresponding to a single target row/column (parts of the first masking state information relating to other rows/columns are ignored). Nevertheless, the first and second masking state information 96, 97 may together define the masked positions across the 2D matrix transpose box as a whole so that it is not necessary to change the masking state data between loading one row/column and the next.

On the other hand, if the selected row/column position is indicated by the first masking state information 96 a masked row/column position, then instead of supplying the data loaded from memory a masking value is written to each of the matrix elements 88 within the selected row/column. Here, each of the elements within the selected row/column may share the same item of first masking state data 96 either identifying all elements in the selected row/column as masked or identifying all matrix elements 88 within the selected row/column as unmasked. When the load instruction specifies a masked row/column; then in response to the masking state information 96 the matrix load circuitry 80 instead writes a masking value to each of the elements within the masked row/column.

Regardless of whether the masking value is supplied to a particular element 88 of the matrix transpose box 74 due to masking of a whole row based on the first masking state data 96 or masking of an individual element based on the second masking state data 97, the masking value can be a predetermined value such as zero, or could be one of a number of alternative masking values that are selectable based on masking selection information which could be stored in a register or within a parameter specified explicitly by the load instruction.

The addressing information 94 could be stored within the general purpose registers 34 of the CPU which are also used for general integer operands, or in some examples could be stored within some dedicated matrix addressing information registers which store information specific to identifying a portion of a matrix structure to be loaded from memory.

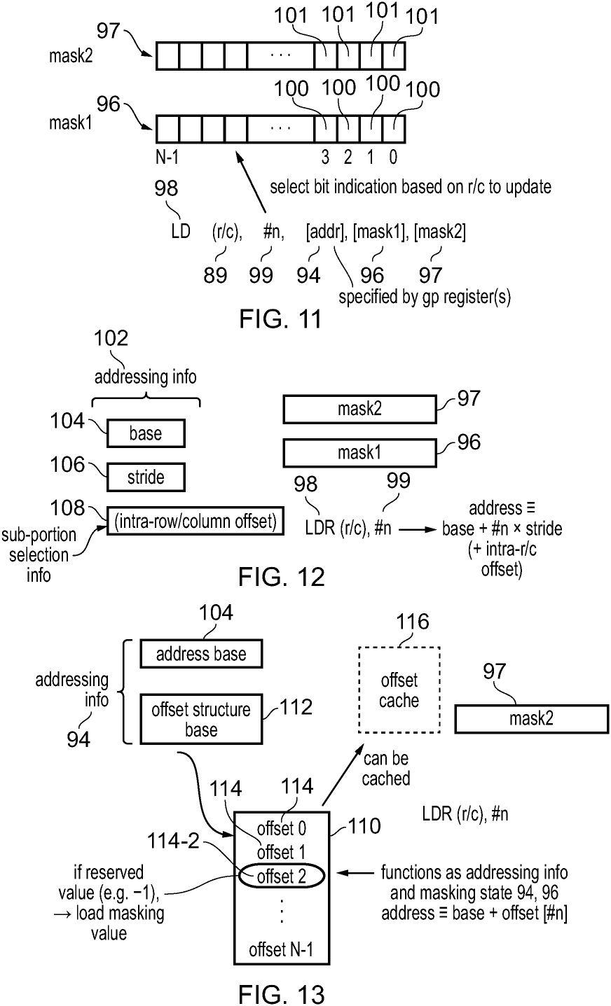

FIGS. 11 to 13 show some examples of ways in which the masking state information and the addressing information 94 can be encoded. In the example of FIG. 11 the addressing information 94 is specified in the general purpose registers 34 also used for integer operands. In this case, then prior to executing the matrix load instruction 98, earlier instructions may need to ensure that the referenced general purpose registers include the appropriate address operands for representing the address of the required row or column of the matrix, and between executing successive load instructions 98 targeting different rows of the input matrix then these address operands would need to be updated to point to the next row or column.

Also in the example of FIG. 11, the first masking state information (mask1) 96 is represented as a bitmap which includes a number of bit flag indicators 100 each corresponding to a given row/column position within the matrix transpose box 74. The row/column number 99 specified by the load instruction 98 is used to select which of the bit flag indicators 100 of the masking bitmap 96 is read, and depending on the value of the read bit flag 100 this controls whether that corresponding row is to be masked or not (e.g. a bit flag of 1 could indicate an unmasked row/column and a bit flag of 0 could indicate a masked row/column, or vice versa).

Similarly, the second masking state information (mask2) 97 is represented as a bitmap which includes a number of bit flag indicators 101 each corresponding to a column/row position (the opposite dimension to the positions indicated by each bit flag indicator 100 in the mask1 bitmap 96), so that mask2 indicates the positions of individual masked elements within the target row/column having the row/column number 99 specified by the load instruction 98 as described above.

The registers storing the first/second masking state information 96, 97 could be dedicated registers for storing the masking state information for masking of matrix operands/processing (and which serve no other purpose), or could serve a dual function so that the same registers could also be used for other information when processing instructions other than matrix processing related instructions. For example, the masking state information 96, 97 could be read from predicate registers, which can also be used to store vector predicates which control masking of lanes of vector processing when a vector instruction is executed.

FIG. 12 shows another example in which again the first/second masking state information 96, 97 is represented as the bitmap the same as in FIG. 11. However, in this case the matrix processing circuitry has access to a set of matrix addressing registers 102 which specify at least a base address 104 and a stride value 106, an optionally specify an intra-row/column offset (sub-portion selection information) 108. With this approach, the addressing information registers 102 can be set prior to performing a group of loads for loading all of the rows or columns of a given input matrix, and it is not necessary to change the addressing information 102 between the individual loads for different rows or columns in the same input matrix, because the matrix load circuitry 80 is able to calculate the address of an individual row/column based on the addressing information 102 and the row/column selection number 99 specified by the load instruction 98. Referring for comparison to the memory layout shown in FIG. 4, the base address 104 can be set to point to the start of a region of memory corresponding to a portion of the matrix to be processed and the stride value 106 can be set to refer to the offset between the address marking the start of one row of the matrix data structure and the address marking the start of the next row (or column if the column-major layout is being used instead). The intra-row/column offset 108 can be used to select an individual portion within one row of the overall matrix structure stored in the memory, which can be useful in cases where the overall matrix structure in memory is larger than the maximum row/column length supported in hardware within the transpose box 74 and the matrix processing logic 84. This allows processing of a large data structure in memory to be broken down into smaller chunks that can be processed in multiple passes by the hardware. Hence, the intra-row/column offset may select the individual portion within a ‘row’ stored in memory. It is not essential to support the intra-row/column offset value 108 as an alternative would be that between processing one chunk of a given row and processing the next chunk the base address 104 could be updated to point to the location of the next chunk, instead of updating the intra-row/column offset value 108. Also, the offset value 108 could instead be provided within a general purpose register which is referenced as a source register by the load instruction.

With this approach, when processing an individual load instruction 98 the matrix load circuitry 80 could calculate the address of the portion of data to be loaded into the selected row or column of the matrix transpose box 74, by adding the base address to the product of the stride value 106 and the row/column number 99 specified by the instruction, optionally offset by the intra-row/column offset value 108 if necessary.

FIG. 13 shows another example of representing the addressing information 94 and the masking state information 96, 97. In this example the addressing information 94 again includes a base address 104, but this time the addressing information also includes an offset data structure 110 which is stored in memory at an location identified by an offset structure base address 112. Here the offset data structure 110 stored in memory functions both as part of the addressing information 94 and also as the first masking state information 96. Second masking state information 97 may still be provided as a separate mask register “mask2” similar to the example of FIGS. 11 and 12.

The offset data structure 110 defines an array of offset values where each offset 114 corresponds to a particular row/column number that can be selected by an individual matrix load instruction 98. When a load instruction specifies a given row/column number (e.g. column 2 as in the example shown in FIG. 10), then the corresponding offset value 114-2 for that column would be selected and the address of the corresponding row/column of data in the matrix structure stored in memory can be derived by adding that selected offset value to the base address stored in the base address register 104. In the majority of cases where the selected row/column is indicated as an unmasked row or column, then the load proceeds as normal.

However, certain offset values are reserved so that they cannot be used for valid offsets but instead indicate the position of a masked row/column. For example the reserved offset value may be -1 (that is a binary value having a most significant bit of 1 and all other bits set to 0 to compliment representation). Hence, when calculating the address for an individual load instruction, if it is determined that the selected offset value 114-2 for the selected row/column number has the reserved value, then this is interpreted as a masked row or column position and therefore instead of performing the actual load from the portion of the matrix data structure stored in memory, instead the relevant row or column group 90, 92 of the matrix transpose box 74 is filled with each of the elements 88 in that row having the masking value, for example zero.

Hence, with this approach the offsets which define the positions in memory from which respective rows or columns of the input matrix are to be loaded into the matrix transpose box also serves as masking state information, which avoids the need for a separate register for the masking state values.

An advantage of using an array 110 of offset values 114 as part of the addressing information is that, compared to an alternative approach of storing a table of absolute addresses indicating the addresses of respective rows/columns of matrix data in memory, this requires much less storage capacity as the offsets can be indicated relative to a common base address and so can be represented using fewer bits. Nevertheless, other implementations could omit the base register 104 in the example of FIG. 13, so that each offset is effectively an offset relative to 0, but this would require more bits for each offset value 114.

Also, the use of a special reserved value of the offset field 110 to represent the masked row/column positions can be more efficient than if padding was supported instead by storing the padding value in memory itself and representing the masked rows/columns by specifying in the field of offset array 110 corresponding to a masked row/columns an offset value which points to the actual location in memory where the padding value is stored. With the special reserved value approach, there is no need to perform an actual load to memory in order to obtain the padding value, as the padding value can instead by generated on the fly by the load circuitry 80 based on detecting the reserved offset value.

While FIG. 13 shows an example where the offset structure 110 is stored in the memory system at addresses derived from the offset structure base address 112, some micro-architectural designs may choose to provide an offset cache 116 in hardware which can cache values of the offset structure for faster access by the matrix load circuitry 80, to avoid needing to fetch them from memory again in future. This recognises that often the pattern of offsets to be applied may be the same for multiple different locations within the matrix so that it is efficient to retain the same offset structure as it may be reused. However, other implementations may provide architecturally required offset registers to store the offset structure 110, so that there is no need to allocate space in memory for the offset structure 110 at all.

Regardless of how the particular masking state information 96, 97 and addressing information 94 is represented, this functionality enables the required portions of a matrix stored in memory to be loaded into the matrix transpose box 74 to permit the 1×1 convolution of operations described earlier to be applied to that portion of the matrix. The masking enables certain lines of the input to be skipped as shown in FIG. 7 to deal with the wraparound problem. Also, by enabling certain rows or columns of the intra-matrix to be masked out this can be useful for supplying padding values to deal with the padded convolutions of the type shown in FIG. 2. Also, in some cases the 2D convolution operation may be being applied to a matrix which has a width or a height which is smaller than the maximum width or height supported in hardware and so the masking state can be used to mask out the unused rows or columns at the end of the matrix.

Having written rows or columns of a given operand matrix into the matrix transpose box 74, the data can be read out in row or column groups by the operand moving circuitry 82 and transferred to the input operand register 70 ready for matrix processing. The operand moving circuitry 82 is not limited to reading out the data from the matrix transpose box 74 in the same row/column direction as the direction which the data was loaded by the matrix load circuitry 80. In practice, it can be useful for the operand moving circuitry 82 to read out the data in the opposite row/column direction to the one used on loading, if the data structure stored in memory for the input operands is stored in a different row/column-major format compared to the output data structure. This on the fly transposition of matrices as they are loaded into the matrix transpose box 74 and read out for processing may be performed in hardware much more efficiently than would be possible from remapping data layouts within memory. Hence, this can greatly improve performance with dealing with input matrices of potentially different memory layouts.

Note that for any given memory layout for a matrix structure stored in memory, it is possible to load that same layout either column-wise or row-wise into the matrix transpose box 74, so whether the row/column selection parameter 89 specifies the row direction or the column direction may be selected totally independently of the actual layout used in the underlying matrix structure in memory. This is because to transpose the direction of the matrix using the matrix transpose box, it is irrelevant whether the data is loaded in column-wise and read out row-wise or whether it is loaded in row-wise and read out column-wise, as these both achieve the same results. In fact, when performing such on the fly transpositions, it can be useful to alternate between loading in matrix data row-wise and loading them in column-wise, to achieve better pipelining of the read out of earlier rows or columns of a matrix for processing and the loading in of later rows or columns of the matrix.

For example, imagine a series of operations where a series of rows of the matrix structure in memory are loaded into rows 0 to 7 of the matrix transpose box 74, but then are read out column wise because the output data structure with which they are being combined has the opposite memory layout. In this case, having loaded the final row 7 into the matrix transpose box, the operand moving circuitry 82 can then start reading out columns one by one starting with column 0 and finishing with column 7. However, as soon as the data for column 0 has been read out, then while the operand moving circuitry 82 continues to read out successive columns 1-7 for processing by the matrix processing object 84, the matrix load circuitry 80 could start loading in further rows of the matrix structure from memory for a next chunk of the matrix to be processed. As columns 1-7 may still be needed for the matrix processing logic 84, it is therefore more efficient to start loading those further rows of the matrix column into the respective columns 0, 1, 2, etc. as those columns successively become free due to the operand moving circuitry reading them out for processing. Hence, the loads for later parts of matrices can be loaded into respective columns of the matrix transpose box 74 at early column positions 0, 1 while the read out for the later columns associated with the previous chunk of matrix is still ongoing. For example once the matrix moves by the operand moving circuitry 82 have read out the data in a certain column, say column 2, then the load into that column for the next pass could start and so this enables some performance improvements by pipelining. Then, once all of the columns have been loaded for the next chunk of the matrix in memory to be processed, the next set of operand moving operations performed by the operand moving circuitry 82 could be performed row wise while loads proceed just behind to fill the row groups 90 of the matrix transpose box just read by the operand moving circuitry 82. Hence, it can be seen that (when on-the-fly transposition is used), by alternating which direction is used for a set of loads, this can provide better performance than if the same row/column direction was used throughout the matrix.

Alternatively, if a particular set of operations is being performed where there is no need for on-the-fly transposition of the matrix layout (e.g. as the output data structure has the same layout in memory as the input data structure), then a fixed one of the row/column directions could be selected for both the matrix load operations and the operand moving operations. Nevertheless, there may still be pipelining so that operands can be read out from certain rows/columns for processing while loads are being performed into other rows/columns.

In the example of FIG. 10, to limit the hardware complexity of the matrix processing logic 84 and the latency associated with an individual instruction, the matrix processing logic 84 does not support performing a complete matrix multiplication operation on two two-dimensional matrix operands in one instruction, but instead such a 2D matrix multiplication operation can be decomposed into a number of separate outer-product-and-accumulate operations each performed on a pair of one-dimensional vector operands. The example of FIG. 7 is used to explain the outer product operations. In the example of FIG. 7, to generate the output matrix 12 from the input matrix 10 and the kernel matrix 11, the example of FIG. 7 requires a matrix multiplication of an 11×4 input matrix 10 by a 4×4 kernel matrix 11 to give an 11×4 output matrix 12. A full matrix multiplication operation would require that a given output element of the output matrix 12 (e.g. the element marked 200 in FIG. 7 at position F′) should be generated based on the sum of pair wise products of the respective elements within a corresponding row 202 of the input matrix 10 and corresponding elements within a corresponding column 204 of the kernel matrix 11. As the matrix multiply is being performed as part of a series of 1×1 convolutions being accumulated to generate the equivalent of a larger 2D convolution, the result of adding the pair-wise products of the row 202 and column 204 is added to the previous value of output matrix 12 for element F′, to generate an updated value for element F′.

However, such a matrix multiply operation would require, for each output element position of the output matrix 12, 4 separate products to be calculated, and then an addition of 5 terms (the 4 products and the previous value of the output element). This may be slow to implement and difficult to fit with pipeline timings of other operations.

In contrast, an outer product operation takes a first vector operand u = (u₁, u₂, ..., uₘ) and a second vector operand v = (v₁, v₂, ..., vₙ) each comprising a one-dimensional array of elements and combines these to form a two-dimensional result matrix W where

$$W = \left[\begin{matrix}{u}_{1} {v}_{1} & ⋯ & {u}_{1} {v}_{n} \\ ⋮ & ⋱ & ⋮ \\ {u}_{m} {v}_{1} & ⋯ & {u}_{m} {v}_{n}\end{matrix}\right] .$$

Hence, each element of the result matrix is derived from a single product of a single element of the input vector operand with a single element of the second vector operand.

For an outer-product-and-accumulate operation, each element of an updated result matrix W also depends on the corresponding element in the previous value of the result matrix

$$\text{W:} {W}^{′} = \left[\begin{matrix}{W}_{1 , 1} + {u}_{1} {v}_{1} & ⋯ & {W}_{1 , n} + {u}_{1} {v}_{n} \\ ⋮ & ⋱ & ⋮ \\ {W}_{m , 1} + {u}_{m} {v}_{1} & ⋯ & {W}_{m , n} + {u}_{m} {v}_{n}\end{matrix}\right]$$

Hence, even for the outer-product-and-accumulate operation, each element requires only the calculation of a single product added to one additional term. This can be performed much faster with lower hardware cost.

The full matrix multiply operation can be decomposed into individual outer product operations. For example, when taking a vector operand 206 as shown in FIG. 7 which corresponds to one column of the 11×4 input matrix and a second vector operand 208 which corresponds to one row of the kernel matrix 11, multiplying each element of the first vector operand 206 with corresponding elements of the second vector operand 208 for each pair of column and row positions gives a 2D array of intermediate results where for example the element 200 identified in FIG. 7 results from the product of the element marked A in column 206 with the top left K1 kernel wait in the row 208 extracted from the kernel matrix 11. By performing iterations of outer-product-and-accumulate operations over each respective combination of column position in the input matrix 10 and row position in the kernel matrix 11, after each combination of input column and kernel row has been processed, the result will be the same as if the full matrix multiply operation had been performed, but with lower hardware cost.

Hence, to support the outer-product-and-accumulate operation performed by the matrix processing logic 84, the input operand registers 70 store one-dimensional vector operands and the operand moving circuitry 82 reads out parts of the input matrix in the matrix transpose box 74 a row or a column at a time. Hence, even though the underlying given operand matrix on which the operations are being performed is a two-dimensional matrix structure, at the point of applying a matrix processing operation it is treated as a series of one-dimensional vector operands, but nevertheless the matrix processing logic 84 is able to generate a result matrix as a two-dimensional matrix structure in one instruction, corresponding to the result of applying the outer product/accumulate operation on a pair of vector operands. This means that the operation is still faster than if individual vector processing instructions were processed which can each only generate a single row/column of a result matrix at a time.

In the example of FIG. 10 the input registers 70 for the matrix processing logic 84 include two input registers A0, A1 for storing a first vector operand and two input registers B0, B1 for storing a second vector operand each. Also, four result matrix registers C0 to C3 72 are provided, each capable of storing a result matrix of two-dimensional extent (while FIG. 10 shows a square matrix of dimensions NxN, other examples could support different height/width for the result matrices). In some implementations the matrix processing logic may be hardwired as to which combination of input registers is used while generating a result matrix to be placed in a given result matrix register 72. For example the result matrix registers C0 to C3 may be generated based on pairs of input operands A0*B0; A0*B1; A1*B0; and A1*B1 respectively. This recognises that often when performing processing of matrices then it may be needed to process the same set of rows or columns of one input matrix and a corresponding set of rows or columns of the second input matrix in different combinations. For example with the 1×1 combination example of FIG. 7, the column 206 of input matrix 10 will be needed not only to be multiplied with the elements in row 208 of the kernel matrix 11 for a first outer product operation, but also to be multiplied with the respective elements in the next row of the kernel matrix 11 for a subsequent outer product operation, and so on for the rest of the rows. Similarly, the kernel rows 208 may need to be multiplied with a number of different columns 206 in the input matrix. By providing sufficient input register storage 70 to store multiple rows or columns at once then the different combinations of rows of columns for operand A and rows or columns for operand B can be implemented with a single set of operand load/move operations to populate the registers 70, and then a number of different matrix processing operations for multiple different combinations of operands can be applied to those operands without needing to repeat the load/move for each individual matrix processing operation. Hence, the approach shown in FIG. 10 using four output matrix registers enables the number of matrix processing instructions processed per matrix load instruction to be increased. Other examples could provide further input/output registers 70, 72, but the precise number of registers chosen may be a trade-off between hardware cost and performance.

Alternatively, other approaches may only provide sufficient input operand register storage 70 for a single vector operand pair, in which case that single pair of vector registers would need to be loaded with the new value for each different combination of row/column of the respective input matrices being multiplied.

Also, it is not essential to provide separate register banks for the two operands A, B. In another example, both operands A and B may be selected from respective registers in a single combined register file.

As shown in FIG. 10 an individual matrix processing instruction 240 may specify a given result destination register 72, a pair of input vector registers 70 to provide the source operands for the operation, and control information including predicate (masking state) information 242 and shift selection information 244. As explained above, in some implementations the selection of the result matrix register 72 to be used for a given operation may be implicit from the combination of source registers 70 selected, and so in this case the instruction may not need to specify a separate destination register identifier, but if a more arbitrary choice of destinations is allowed then it can be useful to provide an additional destination register specifier.

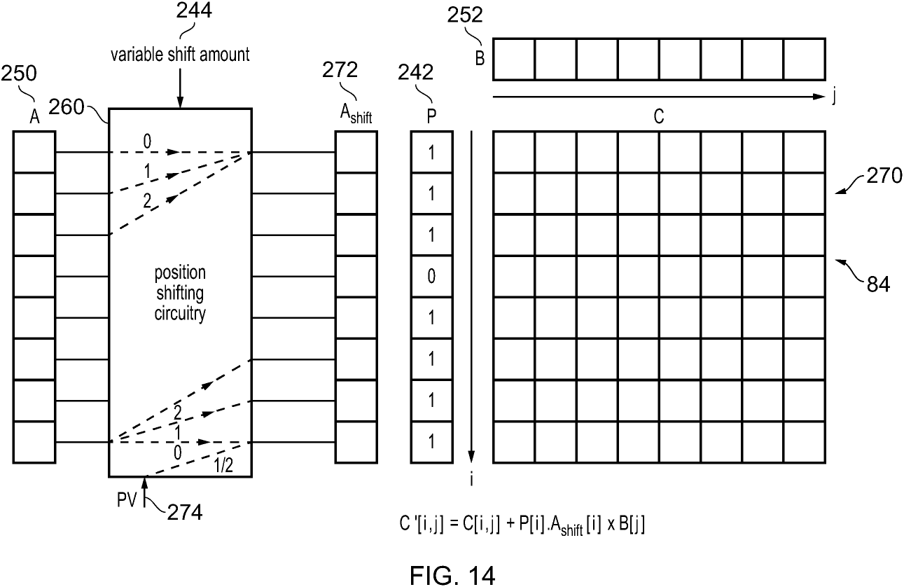

FIG. 14 illustrates the matrix processing logic 84 in more detail, including the use of the predicate information 242 and the shift selection information 244. FIG. 14 shows the vector outer product operation applied to a first vector operand 250 stored in a given one of the “A” input vector registers 70 and a second vector operand 252 stored in a given one of the “B” input vector registers of the operand storage. For example the “A” registers could be used for the input matrix 10 and the B registers could be used for the kernel weights 11 in the convolution examples discussed above.

The matrix processing logic 84 includes position shifting circuitry 260 for applying a variable position shift between the elements of one of the input operands 250 and the corresponding element positions in the output matrix 270 generated in response to the matrix processing instruction 240. The shift information 244 can be represented either as an explicit parameter within the matrix processing instruction 240, or could be represented by a control parameter stored in a control register. The shift parameter 244 specifies one of a number of variable shift amounts. Based on the selected shift amount the positions shifting circuitry activates a number of multiplexers to select which of the input elements from the first vector operand 250 are supplied to each element position within a shifted input operand 272. For example, if a variable shift amount of 0 is selected then each element of the input vector 250 is passed through to the correspondingly positioned element in the shifted input vector 272, while if a variable shift amount of 1 is selected then the element at a given element position within the shifted input vector 272 is set to the value of the element at the next highest element position within the original input vector 250. For the elements at the highest element position within the shifted input vector 272, a padding value 274 can be supplied as there is no higher element position within the original input vector to inject if a variable shift amount greater than 0 is selected. Similarly, for higher values of the shift amount then a larger shift of position can be applied so as to adjust which position of the input vector 250 is supplied through to the shifted positions in the shifted input vector 272. No shift is applied to the second vector operand 252 which is simply used in its original position.

The matrix processing logic 84 then performs the outer product operation so that each element C′[i,j] is generated according to the expression C′[i,j] = C[i,j] + P[i]. A_{shift}[i] × B[j], where i is iterated across all rows of the result matrix C′[i, j] and j is iterated across all columns of result matrix C′[i, j]. Here, the predicate bit P[i] corresponding to a given row position i in the result matrix specifies whether that row is masked (inactive) or unmasked (active). In this example the inactive rows of the output matrix 270 are indicated by predicate bits equal to 0 while the active rows are indicated by predicate bits of 1, but it will be appreciated that other examples could take the opposite mapping of the predicate value so that the inactive rows may be identified using predicate bits of 1 and the active rows by predicate bits of 0. For inactive rows, in this example the corresponding elements of the shifted input vector 272 are assumed to be replaced with a masking value of zero, but other examples could use a non-zero masking value.

Hence, with this approach the variable position shift provided by the position shifting circuitry 260 helps to support the approach shown in FIG. 8 where, having loaded an input operand register 70 with a particular vector 250 representing a given row or column of an input matrix, a number of matrix processing instructions specifying different values of the variable shift amount 244 can be executed, acting on exactly the same contents of the input vector 250 in register 70, to account for the relative position shifts between input vector 250 and output matrix 270 needed for applying the kernel weight for different kernel positions as shown in FIG. 8. This avoids the need to reload the vector operand register 250 for every kernel position. Also, the provision of the predication function using predicate value 242 helps deal with the need to skip certain rows as shown in FIG. 8 to account for the wraparound problem discussed with respect to FIG. 7. The predication can also help to deal with cases where there are insufficient numbers of rows of columns to fill up the whole vector supported in hardware.

While FIG. 14 shows the position shifting circuitry 260 being provided between reading the input vector operand 250 from a given input register 70 and supplying the shifted operand to the matrix processing logic 84 to perform the outer product/accumulate operation, it would also be possible to apply the position shift between the matrix processing logic 84 generating the result of the outer product/accumulate operation and writing the result back to the result matrix register 72, although this approach would be slightly more complex because if an accumulate operation is being performed then this would also require a shift of the portion of the previous values of the output’s matrices which are read as inputs to the outer products/accumulate operation (i.e. C[i,j] in the expression described above).

Hence, providing the features discussed above with respect to FIGS. 10 to 14 helps the matrix processing functionality within a processing pipeline to more efficiently handle 2D convolution operations which are very common in the field of machine learning. It will be appreciated that programmers may find other uses for the same functions, so these do not exclusively need to be used for such 2D convolution operations.

While FIG. 10 shows the matrix transpose box 74 which is useful for allowing different layouts of matrix structures in memory to be processed using the same set of instructions regardless of their stored layout, the matrix transpose box 74 is not essential and some implementations could omit it, and in this case if there is a difference between memory layouts for the input and output matrices then any transposition would need to be handled separately by remapping data stored in memory using load/store instructions prior to applying any matrix processing operations, or by generating the output and then converting its format prior to writing it back into the data structure in memory corresponding to the output. If no matrix transpose box 74 is provided then the matrix load circuitry 80 may instead load rows or columns of the matrix structure in memory directly into the input registers 70 readable by the matrix processing logic when performing the matrix processing operations.

Also, in some implementations it may not be essential to provide the input operand registers 70 at all, as if the matrix transpose box 74 is provided, then another approach could be that the matrix processing logic 84 reads its operands directly from the storage elements 88 of the matrix transpose box 74. Hence, while in general some operand storage circuitry may be provided to be loaded with rows or columns of a matrix by the matrix load circuitry 80 and from which operands can be obtained by the matrix processing logic 84, it is not necessary to provide both the matrix transpose box 74 and the input operand register 70, and either can be provided on their own, or both can be provided in combination as in the example of FIG. 10.

While FIG. 10 shows an example applied to square matrices where the number of rows and columns in the matrices are equal, this is not essential and other examples may support asymmetric numbers of rows and columns.

Performance can be improved to greatest extent if both the row/column masking functionality and the position shifting functionalities described above are provided, but this is not essential and some implementations may provide only one or other of these functionalities.

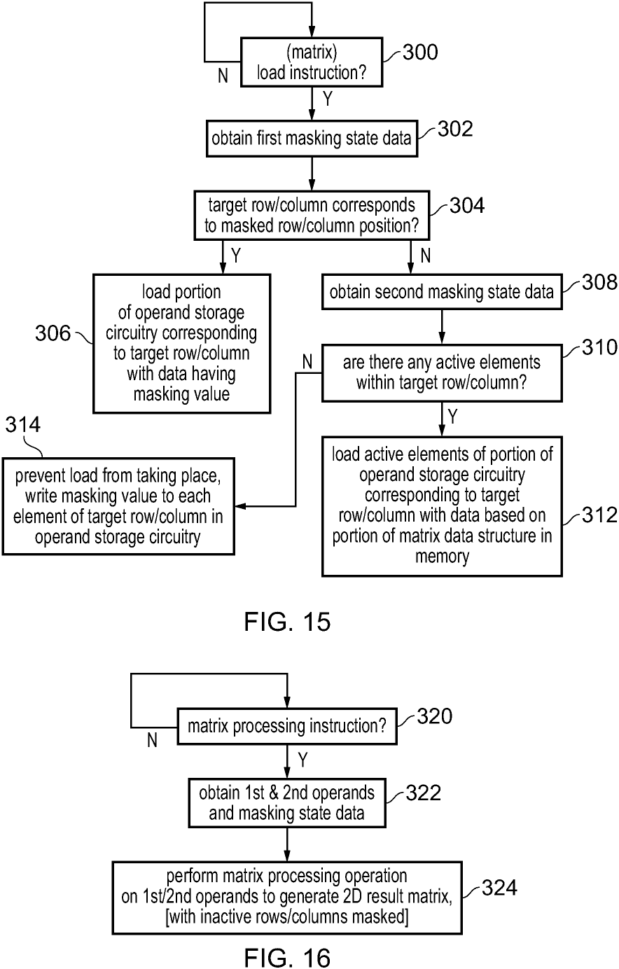

FIG. 15 is a flow diagram showing a method of processing a matrix load instruction, in an example where masking is applied at the point of performing a load operation. When such an instruction is encountered at step 300, at step 302 the instruction decoder 30 decodes the load instruction to generate control signals which controls the matrix load circuitry 80 to obtain the first masking state data 96 either from internal registers within CPU 60 (e.g. in register bank 34 or in internal registers associated with the matrix load circuitry 80), from a data structure 110 in memory, or from an offset cache 116. The first masking state data 96 is “whole row/column” masking state data which indicates whether the entire row/column is masked or not. It is not essential for the entire first masking state data 96 to be obtained by the matrix load circuitry 80 - it can be enough just to reference the masking indication 100 or 114 that corresponds to the row/column number 99 of target row/column to be loaded. Hence, at step 304 the matrix load circuitry determines, based on the obtained first masking state data 96, whether the row/column number 99 specified by the matrix load instruction corresponds to a masked row or column position within the input matrix being processed. If the specified row/column is a masked row/column, then at step 306 the corresponding portion of the operand storage circuitry 74, 70 corresponding to the target row/column is loaded with data having a masking value, instead of actually carrying out load to memory for the corresponding part of the matrix data structure stored in the memory. The masking value can be selected from among a number of options based on a selection parameter encoded by the load instruction or specified elsewhere in a control register. Alternatively, some implementations may always use a fixed masking value by default, such as zero.

On the other hand if the target row or column position is not a masked row or column position, then at step 308 the matrix load circuitry 80 obtains the second masking state data 97, which is per-element masking state data indicating positions of any individual masked column/row positions within the target row/column. At step 310 the matrix load circuitry determines whether there are any active elements within the target row/column (it is possible that even though the first masking state data 96 indicated the target row/column was not masked, the second masking state data 97 may have set all elements in the target row/column to be inactive). If there is at least one active element in the target row/column, then at step 312 the matrix load circuitry 80 triggers a load operation to read from the memory a portion of the matrix data structure which corresponds to the target row or column. The address from which the data is loaded may be derived from the addressing information 94, for example by adding a base address 104 to a multiple of the row/column number and the specified stride 106 in the example of FIG. 12. Having obtained the relevant chunk of data from memory then, for any active elements within that row or column, the loaded data is written to corresponding storage elements 88 of the matrix transpose box 74, or is loaded directly into a corresponding portion of a selected input operand register 70. In contrast, for any inactive elements of the target row/column indicated by the second masking state data 97, the corresponding storage elements 88 or portions of a selected input operand register 70 are filled with the masking value, which could again be zero or non-zero and could be fixed or programmably controlled.

If at step 310 the matrix load circuitry 80 determines that all of the elements in the target row/column are indicated as inactive by the second masking state data 97, then at step 314 the load operation is prevented from taking place, and each element of the target row/column in the operand storage circuitry (i.e. storage elements 88 of the matrix transpose box 74 or an input operand register 70) is filled with the masking value, without needing to perform any load from memory at all.

While FIG. 15 shows two separate steps 302, 308 for obtaining the first and second masking state data 96, 97, other examples could obtain both pieces of masking state data 96, 97 at step 302, before checking whether the target row/column is masked out by the first masking state data 96.

FIG. 16 shows a first example of processing a matrix processing instruction 240 in an embodiment which supports masking applied at the point of matrix processing. At step 320 the instruction decoder 30 of the pipeline identifies that the instruction to be processed is a matrix processing instruction, and generates control signals to control the matrix processing circuitry 46 to process that instruction. In response to these control signals at step 322 the matrix processing logic 84 obtains first and second operands dependent on information stored in the operand storage circuitry 70, 74. As discussed earlier, these operands could be obtained directly from the matrix transpose box 74 or could be obtained from input operand registers 70. Also, the matrix processing circuitry obtains the masking state data 96 (e.g. a predicate vector 242 as shown in FIG. 14), which indicates masked row/column positions for which input values are to be treated as if they represented a masking value. At step 324 the matrix processing circuitry 46 performs a matrix processing operation on the first and second operands to generate a two-dimensional result matrix which can then be written back to one of the result matrix registers 72. For example this operations can be an outer product and accumulate operation as discussed above where the first and second operands are vector operands. For any inactive rows/columns indicated as masked out by the masking state data 96, the corresponding elements of the result matrix may retain their previous values, or alternatively may be set to the values which would have resulted had the corresponding input values been set to a masking value.

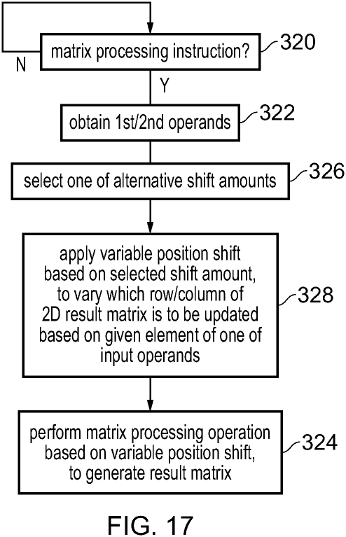

FIG. 17 shows a second example of processing a matrix processing instruction, in an embodiment which supports the variable position shifting feature described with respect to FIGS. 8 and 14. Steps 320, 322 and 324 are similar to the corresponding steps of FIG. 16 (in FIG. 17 the masking feature is not explicitly shown but could still be provided in some embodiments). However, in FIG. 17 the position shifting functionality shown in FIG. 14 is also supported. At step 326 one of a number of alternative shift amounts is selected by the matrix processing circuitry 46 depending on the variable shift amount 244 specified by the matrix processing instruction. While FIG. 14 shows an example with three different possible shift amounts to correspond with the three options shown in FIG. 8, it will be appreciated that other implementations supporting larger kernel sizes may require more than three different shift amounts that can be selected. Alternatively, to limit the complexity of the position shifting circuitry 260, then even if larger kernel sizes are supported the position shift may be limited to a certain maximum size and if there need to be further loads to support the larger kernel sizes then this is still possible.

Hence, at step 328 a variable position shift is applied by the position shifting circuitry 260 based on the shift amount selected at step 326, so that it is varied which row or column of the 2D result matrix 270 is updated based on a given element of one of the input operands 250. At step 324 of FIG. 17, the matrix processing operation is then applied based on the variable position shift to generate the result matrix 270.

Hence, in summary these ideas help support more efficient hardware to support processing of 2D convolution operations which are a common operation in the field of machine learning and image processing.

Further examples are set out in the following clauses:

An apparatus comprising:
matrix processing circuitry to perform a matrix processing operation on first and second input operands to generate a result matrix, where the result matrix is a two-dimensional matrix;
operand storage circuitry to store information for forming the first and second input operands for the matrix processing circuitry; and
position shifting circuitry to apply a variable position shift to vary which row or column of the result matrix is updated based on a given element of one of the first and second input operands stored in the operand storage circuitry during a given matrix processing operation, the variable position shift based on one of a plurality of alternative shift amounts selectable for the given matrix processing operation, each alternative shift amount corresponding to a position shift of said one of the first and second input operands relative to the result matrix by a different number of rows or columns.

The apparatus according to clause (1), in which the first and second input operands comprise one-dimensional vector operands.

The apparatus according to clause (2), in which the matrix processing operation comprises an outer product operation applied to the first and second input operands to generate the result matrix.

The apparatus according to clause (3), in which the outer product operation comprises an outer-product-and-accumulate operation for which the result matrix comprises updated values for respective elements of an accumulator matrix, where the updated value for a given element of the accumulator matrix corresponds to a result of adding a previous value of said given element of the accumulator matrix to a corresponding element of an outer-product result matrix corresponding to a result of performing the outer product operation on the first and second input operands.

The apparatus according to any preceding clause, in which the position shifting circuitry is configured to select said one of the plurality of alternative shift amounts based on a parameter specified by a matrix processing instruction for controlling the matrix processing circuitry to perform the matrix processing operation.

The apparatus according to any preceding clause, in which when a given row or column of the result matrix corresponds to an active row or column position indicated by predicate information accessible to the matrix processing circuitry, the matrix processing circuitry is configured to generate elements of the given row or column of the result matrix having values depending on a corresponding row or column of said one of the first and second input operands, said corresponding row or column selected depending on said one of the plurality of alternative shift amounts selected for the given matrix processing operation; and when the given row or column corresponds to an inactive row or column position indicated by the predicate information, the matrix processing circuitry is configured to generate the elements of the given row or column of the result matrix values having values independent of said corresponding row or column of said one of the first and second input operands.

The apparatus according to any preceding clause, in which the operand storage circuitry comprises matrix transposition circuitry comprising a plurality of storage units to store respective matrix elements for a given operand matrix, in which the storage units of the matrix transposition circuitry are readable in row groups corresponding to rows of the given operand matrix and are also readable in column groups corresponding to columns of the given operand matrix.

The apparatus according to clause (7), in which: when the given operand matrix is written to the matrix transposition circuitry in row groups, the matrix transposition circuitry is configured to support reading the given operand matrix out from the matrix transposition circuitry in column groups; and when the given operand matrix is written to the matrix transposition circuitry in column groups, the matrix transposition circuitry is configured to support reading the given operand matrix from the matrix transposition circuitry in row groups.

The apparatus according to any of clauses (7) and (8), in which the operand storage circuitry comprises operand registers to store the first and second input operands for the matrix processing operation; and
the apparatus comprises operand moving circuitry responsive to a move instruction to read out at least one row or column of the given operand matrix from the matrix transposition circuitry and write said at least one row or column to the operand registers.

The apparatus according to any of clauses (7) to (9), in which the apparatus comprises operand moving circuitry responsive to a matrix processing instruction to read out at least one row or column of the given operand matrix from the matrix transposition circuitry and provide said at least one row or column to the matrix processing circuitry as one of said first and second input operands.

The apparatus according to any preceding clause, comprising load circuitry responsive to a load instruction to load information corresponding to a target row or column of a given operand matrix to the operand storage circuitry based on a portion of a matrix data structure stored in memory; in which: in response to the load instruction, the load circuitry is configured to obtain masking state data for indicating one or more masked row or column positions within the given operand matrix, and when the target row or column corresponds to a masked row or column position indicated by the masking state data, the load circuitry is configured to load a portion of said operand storage circuitry corresponding to the target row or column with data having a masking value instead of data based on the portion of the matrix data structure stored in memory.

The apparatus according to any preceding clause, in which the matrix processing circuitry is configured to generate the result matrix from the first and second input operands in response to a single instruction.

An apparatus comprising: means for performing a matrix processing operation on first and second input operands to generate a result matrix, where the result matrix is a two-dimensional matrix; means for storing information for forming the first and second input operands for the means for performing; and means for applying a variable position shift to vary which row or column of the result matrix is updated based on a given element of one of the first and second input operands stored in the means for storing during a given matrix processing operation, the variable position shift based on one of a plurality of alternative shift amounts selectable for the given matrix processing operation, each alternative shift amount corresponding to a position shift of said one of the first and second input operands relative to the result matrix by a different number of rows or columns.

A data processing method comprising: performing a matrix processing operation on first and second input operands to generate a result matrix, where the result matrix is a two-dimensional matrix and the first and second input operands are dependent on information stored in operand storage circuitry; and during a given matrix processing operation, applying a variable position shift to vary which row or column of the result matrix is updated based on a given element of one of the first and second input operands stored in the operand storage circuitry, the variable position shift based on one of a plurality of alternative shift amounts selectable for the given matrix processing operation, each alternative shift amount corresponding to a position shift of said one of the first and second input operands relative to the result matrix by a different number of rows or columns.

In the present application, the words “configured to...” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1-25. (canceled)

26. An apparatus comprising:
matrix processing circuitry to perform a matrix processing operation on first and second input operands to generate a result matrix, where the result matrix is a two-dimensional matrix;
operand storage circuitry to store information for forming the first and second input operands for the matrix processing circuitry; and,
masking circuitry to perform a masking operation to mask at least part of the matrix processing operation or the information stored to the operand storage circuitry based on masking state data indicative of one or more masked row or column positions to be treated as representing a masking value.

27. The apparatus according to claim 26, in which the masking value is zero.

28. The apparatus according to claim 26, in which the masking value is selected from a plurality of masking values depending on at least one of:
a masking value selection parameter specified by an instruction which causes the masking operation to be performed;
a control value stored in a control register; and,
a masking vector specifying separate masking values for a plurality of elements of a masked row/column.

29. The apparatus according to claim 26, in which the masking state data has an encoding identifying within a two-dimensional array of elements, elements to be treated as representing the masking value.

30. The apparatus according to claim 29, in which the masking state data specifies:
first masking state data indicative of one or more masked rows or column positions for which all elements in the masked row or column position are to be treated as representing the masking value; and
second masking state data indicative of whether individual element positions within a given row or column are to be masked or not.

31. The apparatus according to claim 26, in which the masking state data has an encoding capable of indicating, as masked row or column positions, at least two non-adj acent row or column positions separated by at least one non-masked row or column position.

32. The apparatus according to claim 26, in which the operand storage circuitry comprises matrix transposition circuitry comprising a plurality of storage units to store respective matrix elements of a given operand matrix, in which the storage units of the matrix transposition circuitry are readable in row groups corresponding to rows of the given operand matrix and are also readable in column groups corresponding to columns of the given operand matrix.

33. The apparatus according to claim 32, in which:
when the given operand matrix is written to the matrix transposition circuitry in row groups, the matrix transposition circuitry is configured to support reading the given operand matrix out from the matrix transposition circuitry in column groups; and
when the given operand matrix is written to the matrix transposition circuitry in column groups, the matrix transposition circuitry is configured to support reading the given operand matrix from the matrix transposition circuitry in row groups.

34. The apparatus according to claim 26, in which:
the matrix processing circuitry comprises the masking circuitry, and is responsive to said masking information to perform said matrix processing operation with a portion of one of said first and second operands corresponding to said one or more masked row or column positions treated as representing the masking value instead of an actual value of said portion of said one of said first and second operands stored in the operand storage circuitry.

35. The apparatus according to claim 26, comprising load circuitry responsive to a load instruction to load information corresponding to a target row or column of a given operand matrix to the operand storage circuitry based on a portion of a matrix data structure stored in memory; in which:
the load circuitry comprises the masking circuitry, and when the target row or column corresponds to a masked row or column position indicated by the masking state data, the load circuitry is configured to load a portion of said operand storage circuitry corresponding to the target row or column with data having the masking value instead of data based on the portion of the matrix data structure stored in memory.

36. The apparatus according to claim 35, in which in response to the load instruction, when the masking state data corresponding to the target row or column indicates that the target row or column corresponds to a masked row or column position, the load circuitry is configured to determine whether each of a plurality of matrix elements of the target row or column should be masked, based on a shared item of masking state data shared between the plurality of matrix elements of the target row or column.

37. The apparatus according to claim 35, in which the masking state data comprises a plurality of offset values each corresponding to a respective row or column position of the given operand matrix and indicative of an offset of an address of a corresponding portion of the matrix data structure in memory relative to a base address; and
the masked row or column position is indicated by the offset value for the masked row or column position having a predetermined reserved offset value.

38. The apparatus according to claim 35, in which the load circuitry is configured to obtain the masking state data from memory, based on masking state addressing information stored in at least one masking state addressing register.

39. The apparatus according to claim 36, in which the load circuitry is configured to determine a target address of the portion of the matrix data structure in memory based on addressing information.

40. The apparatus according to claim 39, in which the addressing information comprises a plurality of address pointers, each address pointer indicating an address of a portion of the matrix data structure corresponding to a respective row or column position of the given operand matrix.

41. The apparatus according to claim 39, in which the addressing information comprises:
a base address of the matrix data structure; and
one of:
a stride value indicative of a difference between an address of the portion of the matrix data structure corresponding to one row or column of the given operand matrix and an address of the portion of the matrix data structure corresponding to the next row or column of the given operand matrix; and.
offset information comprising one of:
a plurality of offset values each corresponding to a respective row or column position of the given operand matrix and indicative of an offset of an address of a corresponding portion of the matrix data structure in memory relative to the base address; and
an offset data structure address indicating an address of a data structure in memory providing said plurality of offset values.

42. The apparatus according to claim 39, the addressing information further comprising sub-portion selection information to select which sub-portion of the portion of the matrix data structure in memory identified based on the addressing information is to be loaded to the operand storage circuitry.

43. The apparatus according to claim 39, comprising at least one addressing register to store the addressing information; and
prefetch circuitry to generate prefetch requests for prefetching portions of the given operand matrix from memory depending on the addressing information stored in the at least one addressing register.

44. The apparatus according to claim 26, in which the first and second input operands are one-dimensional vector operands.

45. A data processing method comprising:
storing, in operand storage circuitry, information for forming first and second input operands for a matrix processing operation; and
performing a matrix processing operation on the first and second input operands to generate a result matrix, where the result matrix is a two-dimensional matrix; and
performing a masking operation to mask at least part of the matrix processing operation or the information stored to the operand storage circuitry based on masking state data indicative of one or more masked row or column positions to be treated as representing a masking value.
